(19) United States
(12) Patent Application Publication
(10) Pub. No.: US 2026/0229973 A1
(43) Pub. Date: Aug. 6, 2026

(54) STATOR WINDING OF AN AXIAL FLUX INDUCTION MACHINE

(71) Applicant: AURA SYSTEMS, INC., Lake Forest, CA (US)

(72) Inventors: Ali Sarikhani, Mission Viejo, CA (US); Milad Darzi, Long Beach, CA (US); Maryam Besharati-Givi, Lake Forest, CA (US); Harry Kurtzman, Lake Forest, CA (US)

(21) Appl. No.: 19/042,427

(22) Filed: Jan. 31, 2025

(51) Int. Cl. H02K 17/28

(52) U.S. Cl. CPC H02K 17/28

(57) ABSTRACT

An axial flux stator includes a stator core and a coil winding assembly. The stator core is disposed within a housing and has a plurality of stator teeth and slots defined between each pair of consecutive stator teeth. The coil winding assembly is disposed within the multiple slots and around the plurality of stator teeth. The coil winding assembly allows an electric current to pass through the coil winding assembly to generate an electromagnetic field in an axial direction with respect to a rotor to rotate the rotor. The coil winding assembly has three overlapped coil subassemblies including a first, second, and third phase coil subassemblies. Each of the three overlapped coil subassemblies has one or more coils extending continuously around the stator core and arranged in a respective serpentine path through a respective group of slots of the plurality of slots.

### TECHNICAL FIELD

This disclosure relates to induction machines, and more specifically to axial flux induction machines.

### BACKGROUND

Electric motors and machines are widely used in various applications due to their robust design, reliability, and efficiency. Induction motors are a type of electric motor that operate on the principle of electromagnetic induction, where an alternating current (AC) in the stator windings generates a rotating magnetic field that induces a current in the rotor to rotate the rotor. Induction motors and machines can have a radial flux design or an axial flux design. Axial flux induction motors and machines have an axial flux design, in which the magnetic flux flows parallel to the axis of the shaft. This configuration features high power density and efficiency, making axial flux induction machines a good fit for applications where space and weight are critical. Improvements to axial flux induction machines are continuously sought.

### SUMMARY

Implementations of the present disclosure include an axial flux stator that includes a stator core and a coil winding assembly. The stator core is disposed within and coupled with a housing of an axial flux induction machine and has a plurality of stator teeth and a plurality of slots defined between each pair of consecutive stator teeth. The coil winding assembly is disposed within the multiple slots and around the plurality of stator teeth. The coil winding assembly allows an electric current to pass through the coil winding assembly to generate an electromagnetic field in an axial direction with respect to a rotor disposed within the housing to rotate the rotor. The coil winding assembly has three overlapped coil subassemblies including a first phase coil subassembly, a second phase coil subassembly, and a third phase coil subassembly. Each of the three overlapped coil subassemblies has one or more coils extending continuously around the stator core and arranged in a respective serpentine path through a respective group of slots of the plurality of slots.

In some implementations, the first phase coil subassembly includes a first coil set, the second phase coil subassembly includes a second coil set, and the third phase coil subassembly includes a third coil set. The first coil set includes a first pair of conductor strands arranged in a first serpentine path through a first group of slots of the plurality of slots and a second pair of conductor strands interlocked with the first pair of conductor strands and arranged in a second serpentine path through the first group of slots. The second serpentine path is offset with respect to the first serpentine path.

In some implementations, the second coil set includes a third pair of conductor strands arranged in a third serpentine path through a second group of slots of the plurality of slots and a fourth pair of conductor strands arranged in a fourth serpentine path through the second group of slots. The fourth serpentine path is offset with respect to the third serpentine path, and the third coil set includes a fifth pair of conductor strands arranged in a fifth serpentine path through a third group of slots of the plurality of slots and a sixth pair of conductor strands arranged in a sixth serpentine path through the third group of slots. The sixth serpentine path is offset with respect to the fifth serpentine path.

In some implementations, the first group of slots includes each first slot of each three consecutive slots of the plurality of slots. The second group of slots includes each second slot of each three consecutive slots of the plurality of slots, and the third group of slots includes each third slot of each three consecutive slots of the plurality of slots such that each of the three overlapped coil subassemblies are mechanically and electrically arranged to have a different phase shift from one another.

In some implementations, the first pair of conductor strands includes two round conductor strands extending parallel with respect to each other along the first serpentine path, and the second pair of conductor strands includes two round conductor strands extending parallel with respect to each other along the second serpentine path.

In some implementations, the first phase coil subassembly includes a first stack of coil sets including the first coil set and a first plurality of coil sets electrically connected to the first coil set. The second phase coil subassembly includes a second stack of coil sets including the second coil set and a second plurality of coil sets electrically connected to the second coil set. The third phase coil subassembly includes a third stack of coil sets including the third coil set and a third plurality of coil sets electrically connected to the third coil set.

In some implementations, the first stack is electrically connected in parallel, the second stack is electrically connected in parallel, and the first stack is electrically connected in series with the second stack.

In some implementations, each coil set of the first plurality of coil sets are welded to each other and to the first coil set, each weld point joining a parallel pair of conductor strands of one of the first plurality of coil sets to a parallel pair of conductor strands of a subsequent one of the first plurality of coil sets.

In some implementations, the first pair of conductor strands includes a first end electrically coupled with a subsequent pair of conductor strands and a second end electrically coupled with a first phase terminal. The second pair of conductor strands includes a first end electrically coupled with a subsequent pair of conductor strands and a second end electrically coupled with the first phase terminal. Am end of the first phase coil subassembly is electrically coupled with a neutral terminal. In some implementations, the second phase coil subassembly includes a first end electrically coupled with a second phase terminal and a second end electrically coupled with the neutral terminal, and the third phase coil subassembly includes a first end electrically coupled with a third phase terminal and a second end electrically coupled with the neutral terminal.

In some implementations, the coil winding assembly includes a solid, pre-shaped, hair pinned round coil winding. In some implementations, the coil winding assembly includes at least one of aluminum or copper. In some implementations, a fill factor of the coil winding assembly is between 55% and 75%.

In some implementations, each of the three overlapped coil subassemblies are electrically isolated from one another.

In some implementations, the first phase coil subassembly is arranged to have a first phase current. The second phase coil subassembly is arranged to have a second phase current, and the third phase coil subassembly is arranged to have a third phase current such that together, the three overlapped coil subassemblies generate a balanced three-phase current that generates a rotating magnetic field to rotate the rotor to generate torque with the rotor.

Implementations of the present disclosure include an axial flux induction machine that includes a housing, a shaft, a first axial flux stator, a second axial flux stator, and an axial flux rotor. The shaft is rotatably coupled with the housing. The first axial flux stator is coupled with and disposed within the housing. The second axial flux stator is coupled with and disposed within the housing. The axial flux rotor is disposed within the housing and resides between the first and second axial flux stators. The axial flux rotor is coupled with the shaft and is rotatable with respect to the first and second axial flux stators. Each of the first and second axial flux stators includes a stator core and a coil winding. The stator core includes a plurality of stator teeth and a plurality of slots defined between each pair of consecutive stator teeth of the plurality of stator teeth. The coil winding assembly is disposed within the plurality of slots and around the plurality of stator teeth. The coil winding assembly includes three overlapped coil subassemblies including a first phase coil subassembly, a second phase coil subassembly, and a third phase coil subassembly. Each of the three overlapped coil subassemblies includes one or more coils extending continuously around the stator core and arranged in a respective serpentine path through a respective group of slots of the plurality of slots.

In some implementations, the first phase coil subassembly includes a first coil set, the second phase coil subassembly includes a second coil set, and the third phase coil subassembly includes a third coil set. The first coil set includes a first pair of conductor strands arranged in a first serpentine path through a first group of slots of the plurality of slots and a second pair of conductor strands interlocked with the first pair of conductor strands and arranged in a second serpentine path through the first group of slots. The second serpentine path is offset with respect to the first serpentine path.

In some implementations, the first pair of conductor strands includes two round conductor strands extending parallel with respect to each other along the first serpentine path, and the second pair of conductor strands includes two round conductor strands extending parallel with respect to each other along the second serpentine path.

In some implementations, the first phase coil subassembly includes a first stack of coil sets including the first coil set and a first plurality of coil sets electrically connected to the first coil set. The second phase coil subassembly includes a second stack of coil sets including the second coil set and a second plurality of coil sets electrically connected to the second coil set, and the third phase coil subassembly includes a third stack of coil sets including the third coil set and a third plurality of coil sets electrically connected to the third coil set.

In some implementations, the coil winding assembly includes a fill factor of between 55% and 75%.

In some implementations, the axial flux induction machine further includes a control system electrically coupled with and configured to transmit power to the first and second axial flux stators. The power including three phases.

Implementations of the present disclosure include a method of installing a solid coil winding in an axial flux motor stator. The method includes forming a first coil set of a coil winding assembly such that the first coil set fits within a first serpentine path that extends through a first group of slots of a plurality of slots of a stator core of an axial flux induction motor. The stator core includes a plurality of stator teeth and the plurality of slots are defined between each pair of consecutive stator teeth of the plurality of stator teeth. The method also include disposing the first coil set within a section of the plurality of slots of the stator core and around a section of the plurality of stator teeth such that the first coil set resides within the first serpentine path. The method also includes forming a second coil set of a coil winding assembly such that the second coil set fits within a second serpentine path that extends through a second group of slots of the plurality of slots. The method also includes disposing the second coil set within the section of the plurality of slots of the stator core and around the section of the plurality of stator teeth such that the second coil set resides within the second serpentine path. The second serpentine path is offset with respect to the first serpentine path.

In some implementations, disposing the first coil set and second coil set includes disposing a first phase coil subassembly within the section of the plurality of slots. The method further includes disposing a second phase coil subassembly within a second set of the plurality of slots and disposing a third phase coil subassembly within a third set of the plurality of slots such that the first, second, and third phase coil subassemblies are interlocked with one another.

Particular implementations of the subject matter described in this specification can be implemented so as to realize one or more of the following advantages. For example, the axial flux induction machine of the present disclosure features enhanced flux-carrying capacities and improved electrical conductivity as compared to traditional axial flux machines such as distributed winding axial flux motors with stranded wire and random coil pattern. Moreover, the axial flux induction machine of the present disclosure is capable of highly efficient operation and achieves significantly greater torque forces compared to other comparably-sized axial flux motors and generators. Additionally, the axial flux induction machine of the present disclosure features a stator slot conductor fill factor greater than the fill factor of traditional axial flux induction machines. Moreover, the axial flux induction machine of the present disclosure has open passages in between conductors residing in the stator slots, which allows the conductors and the stator to be efficiently cooled. The axial flux induction machine of the present disclosure also has a balanced parallel path in the motor with isolated neutrals, which can increase the efficiency of the induction machine through better control of the electromagnetic fields and reduction of interference. Moreover, the winding configuration of the axial flux induction machine allows the winding process to be automated, which can help increase production speed and save time and resources.

### BRIEF DESCRIPTION OF THE DRAWINGS

FIG. 1 is a perspective, exploded view of an example of an axial flux induction machine.

FIG. 2A is a side cross-sectional view of the example of the axial flux induction machine in FIG. 1.

FIG. 2B is a side cross-sectional view of an example of an axial flux induction machine according to a different implementation.

FIG. 3 is a perspective view of the example of the axial flux induction machine in FIG. 1.

FIG. 4 is a perspective view of the rotor and stators of the example of the axial flux induction machine in FIG. 1.

FIG. 5 is a top view of an example of a stator.

FIG. 6 is a top view of an example of a stator core with a coil of a coil winding assembly.

FIG. 7 is a perspective view of an example of a coil set of the coil winding assembly.

FIG. 8 is a perspective view of an example of the two interlocked coil sets of the coil winding assembly.

FIG. 9 is a perspective view of a section of an example of a stator.

FIG. 10 is a perspective view of the axial flux induction machine in FIG. 1 with a cooling system.

FIG. 11 is a side cross-sectional view of the axial flux induction machine in FIG. 1 with the cooling system.

FIG. 12 is a perspective view of an example of a stator with tubular cap seals off.

FIG. 13 is a perspective view of an example of a stator with tubular cap seals on.

FIG. 14 is a perspective view of a section of an example of a stator with slot seals.

FIG. 15 is a perspective view of an example of a stator with the slot seals uninstalled.

FIG. 16 is a perspective view of a section of a slot of the example stator.

FIG. 17 is a cross-sectional view of a section of the example stator with slot seals.

FIG. 18 is a perspective view of an example rotor assembly.

FIG. 19 is a perspective, exploded view of an example rotor of the example rotor assembly.

FIG. 20 is a top cross-sectional view of an example rotor with cooling pathways.

FIG. 21 is a perspective view of the example rotor with a cooling system.

FIG. 22 is a flow chart of an example of a method of cooling a stator.

FIG. 23 is a flow chart of an example of a method of cooling a rotor.

FIG. 24 is a flow chart of an example of a method of installing a coil winding assembly on a stator core.

FIG. 25 is a schematic illustration of an example of a control system for an axial flux induction machine.

### DETAILED DESCRIPTION OF THE DISCLOSURE

Generally, axial flux induction motors have higher power density than radial flux motors. One reason for this is the larger surface area of the stator to rotor. For example, in axial flux machines, the conductors pass through stator slots that extend in the radial direction with respect to the axis of rotation, whereas in radial flux machines, the conductors pass through stator slots extending in the axial direction. This difference between conductor placement in the slots of axial flux machines can lead to a greater coil area as compared to radial flux machines. This allows axial flux machines to have higher power per unit volume. These advantages enable the design of small, high-power dense motors.

Many axial flux machines are designed with a stranded wire and random coil pattern. In some aspects, such a configuration leads to a decrease in the copper to stator slot area fill factor and results in increased current density (current per surface area of coils). Such an increase in density can result in dense heat generation in the stator assembly of the axial flux motor which, if not managed properly, can lead to insulation system life drop expectancy and insulation system failure.

In some cases, as the current density of the axial flux induction machine increases, the cooling capacity/requirement of the axial flux induction machine increases. Thus, with an increased requirement for cooling, and since substantial heat is generated in the stator winding, the design and arrangement of the stator winding become very important to the performance of the machine. Axial flux induction machines with distributed winding with random coil pattern tend to prevent the flow of fluid through the stator slots, whereas the coil winding of the present disclosure allows fluid to flow directly through the conductors/wires of the coil winding in the slots.

Axial flux induction machines with distributed winding with random coil pattern can also present challenges with respect to electrical compatibility and resistance. For example, it can be difficult to ensure that a three-phase axial flux induction machines with distributed winding with random coil pattern has three balanced coils sets in which each coil set is formed from one or more parallel paths (where all parallel paths are electrically compatible with each other and possess equal electrical resistance). This is difficult at least because the length of the paths of the coil winding is such a machine are very different in length. Also, designing such machines with isolated neutrals is difficult because of the placement of the terminals of each wire in the coil winding. These challenges can complicate the design, manufacturing, and operation of axial flux induction machines that have distributed winding with random coil pattern.

The axial flux induction machine of the present disclosure features a stator winding design that provides a gap between conductors in the stator slots to serve as a cooling fluid passage. In some implementations, the stator winding design of the present disclosure also increases the usage of copper in a slot to reduce the electric current density. The stator winding design can also reduce the end coil length, resulting in reduced electrical resistance. Also, the stator winding design can help balance the stator winding parallel paths and achieves equal or similar electrical resistance between each parallel path in each phase.

The axial flux induction machine of the present disclosure can have one or more stators and a rotor. In some implementations, the stators convert electrical energy to magnetic energy by providing a magnetic coupling between a magnetic flux of the stators and the rotor. The stators can have coils and magnetic steel. The coils can be connected in a unique fashion to generate rotating magnetic flux. In some implementations, the rotor has magnetic and conductive bodies to interact with the magnetic circuit of the stator body, generating a magnetic field and as a result generating magnetic force. In some implementations, the stators provide conductive paths in radial and circumferential direction for electrical current to circulate in the “X and Y plane” and generate a magnetic field in an axial direction, along the “Z plane.” The stator has high electrical conductivity in radial and circumferential direction and high magnetization property in the Z direction.

Due to the nature of the Ohmic and eddy current loss in conductive and magnetic paths, the cooling of the rotor and stators for high power motors has been a challenge. In the stators, the coils and magnetic steel can be the major elements in the generation of loss and heat in axial flux induction machine. The axial flux induction machine of the present disclosure has a stator cooling system that facilitates the full coolant circulation within the body of the stator areas while maintaining the stator fluidly sealed.

In some implementations, the axial flux induction machine of the present disclosure has a stator cooling system and design that allows immersion fluid (e.g., liquid) cooling of the coil winding in the stators. Unlike traditional axial flux motors, the axial flux induction machine of the present disclosure can allow fully (or partially) submerged cooling of the coil winding. Forced oil cooling system is a method to enhance the heat removal from axial flux induction machines leading to higher efficiency and at the same time enhancing the life and reliability of the insulation system.

In some aspects, if the rotor is not fluidly isolated or properly sealed from the cooling fluid of the stators, the axial flux induction machine can experience substantial mechanical rotational loss in the rotor. The stator cooling system of the present disclosure seals the cooling fluid from the rotating part of the rotor, reducing or eliminating rotational loss due to cooling fluid leakage. Moreover, if the forced oil cooling loses contact area in the regions where the copper is embedded within the laminations in each slot, the coil cannot be properly cooled. The stator cooling system of the present disclosure can increase the contact area of the cooling fluid with the loss generation bodies such as stator lamination and coils. Moreover, if the cooling fluid is not circulated properly, the coil and stator cannot be properly cooled. The stator cooling system of the present disclosure can increase the circulation of the cooling fluid within the confined body of the stator housing because of the gap between the coil strands.

Moreover, the axial flux induction machine of the present disclosure has a rotor that increases the electrical conduction and magnetic permeability of the rotor, and that facilitates coolant circulation within the body of the rotor while maintaining the rotor fluidly sealed. The rotor of the present disclosure has two or more solid bodies, one magnetic and one conductive, interfaced together in a homogeneous way. Such arrangement can increase the electrical conduction in the radial direction and at the same time increase the magnetic permeability in the axial direction. The magnetic permeability can be described as the measure of magnetization produced in a material in response to an applied magnetic field. Thus, the rotor of the present disclosure can reduce or eliminate the magnetic flux leakage in the rotor.

In some implementations, the rotor of the present disclosure has a cooling circuit embedded within two bodies, which allows the rotor to be efficiently cooled internally, minimizing the rotor power loss and increasing the efficiency of the axial flux induction machine.

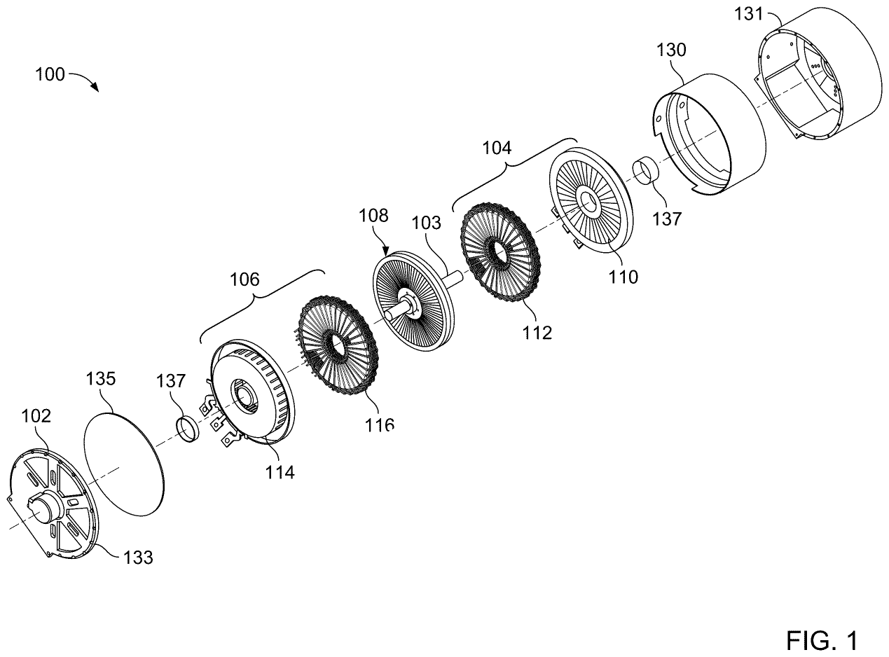

FIG. 1 is an exploded view of an example of an axial flux induction machine 100. The axial flux induction machine 100 can be, for example, an axial flux induction motor, generator, alternator, or starter. The axial flux induction machine 100 of FIG. 1 is illustrated as a three-phase axial flux induction motor. The axial flux induction machine 100 has a shaft 103, a rotor 108 (e.g., an axial flux rotor 108), two stators 104, 106 (e.g., axial flux stators 104, 106), and a housing 102. When assembled, the rotor 108, part of the shaft 103, and two stators 104, 106 reside inside the housing 102. The housing 102 includes a housing body 131 and a cap 133. The axial flux induction machine 100 can also include other components such as a seal cylinder 130, rings 137 (e.g., bushings, slip rings, commutator rings, etc.), and seal ring 135 (e.g., an O-ring).

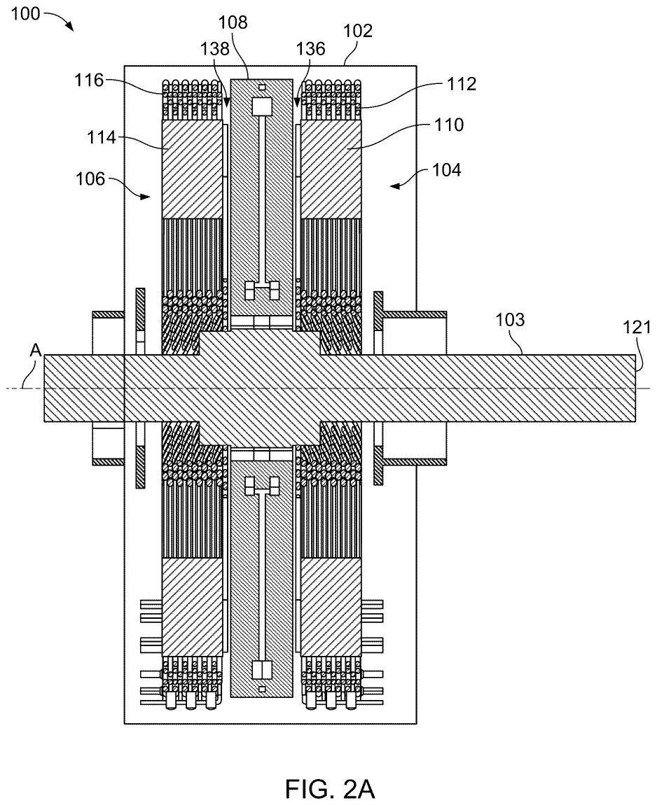

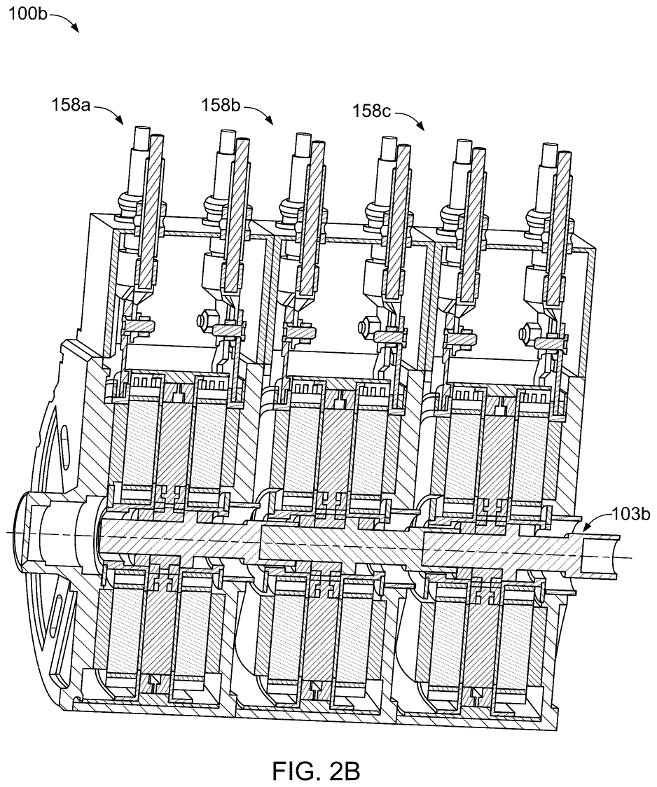

Referring also to FIG. 2, when assembled, the two stators 104, 106 are coupled with (e.g., fixed to) the housing 102. The rotor 108 is mounted onto and coupled with the shaft 103. The rotor 108 resides in close proximity with and between the two stators 104, 106. The shaft 103 is rotatably attached (e.g., using bearings) with the housing 102 so that the shaft and the rotor 108 rotate together with respect to the housing 102 and the stators 104, 106.

Each stator 104, 106 includes a stator core 110, 114 and a coil winding assembly 112, 116 (e.g., stator field windings, coils, etc.). Each stator 104, 106 converts electrical energy to magnetic energy by providing a magnetic coupling between a magnetic flux of the stator and the rotor. As shown in FIG. 2A, stator 104, 106 faces each other and is sufficiently spaced away from the rotor 108 to define an air gap 136, 138 therebetween. As shown, the first stator 104 is spaced from the rotor 108 by a first air gap 1136 and the second stator 106 is spaced from the rotor 108 by a second air gap 138.

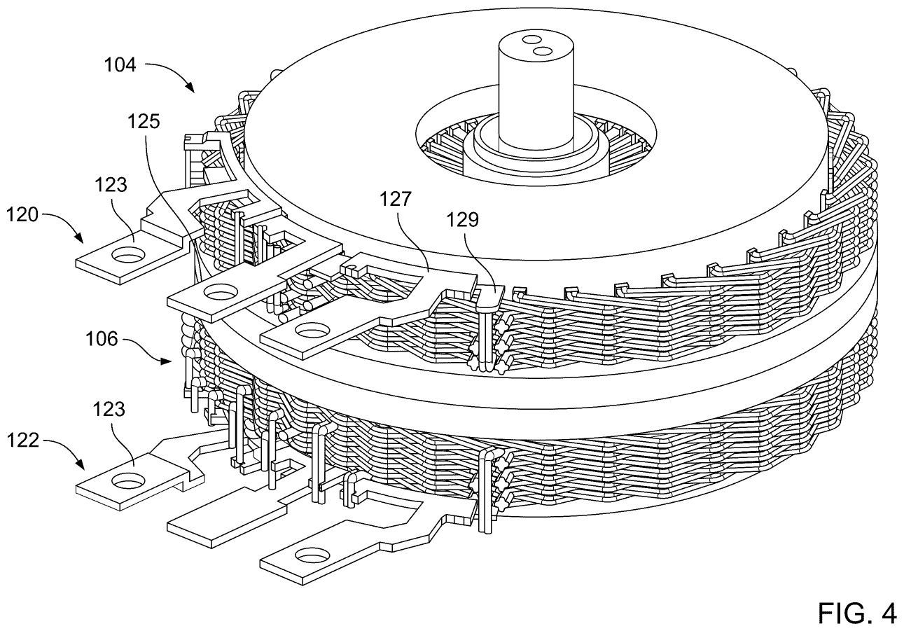

The stators 104, 106 are in a mirrored symmetrical relationship to each other. The rotor 108 rotates about an axis of rotation “A.” The coil winding assemblies 112, 116 are formed to fit into the available space provided by the housing 102. Each coil winding assembly 112, 116 can be made of copper or aluminum. In some implementations, as further described in detail below with respect to FIGS. 4-8, each coil winding assembly 112, 116 includes a solid, pre-shaped, hair pinned round coil winding.

The symmetric mirrored placement of the stators 104, 106 causes the magnetic flux in the current carrying volume of the rotor 108 to be maintained perpendicular to the currents and parallel to the axis of rotation “A.” The positioning of the axial flux stators 104, 106 on both sides of the rotor 108 enhances the flux through the rotor 108 because less stator length is required for copper wire. In other words, the magnetic flux through the rotor 108 increases without decreasing the electrical conductivity through the rotor 108. In some implementations, the axial flux induction machine 100 includes one stator. For example, to reduce the size of the housing, the housing 102 can house only one stator to rotate the rotor 108.

The housing 102 provides structural support to the components inside the housing 102 to withstand the high levels of internal magnetic loads, electrical loads, and centrifugal force created during operation of the axial flux induction machine 100. Moreover, the shaft 103 holds the rotor 108 securely under both radial and axial loading, holding the rotor 108 precisely between the stators 104, 106 under all load conditions.

An end 121 of the shaft 103 extends out the front or back of the housing 102. For example, in some implementations, the shaft 103 is an output shaft with the end 121 of the shaft 103 connected, for example, to a wheel or an input shaft of a gearbox. In some implementations, the axial flux induction machine 100 is a generator, in which the shaft 103 is an input shaft that receives rotational energy (e.g., through a pulley, a gearbox, a crank, an engine, an actuator, etc.) to rotate the rotor 108 and generate electrical power. In such cases, the output of the axial flux induction machine 100 is electrical power (e.g., three-phase electrical power).

FIG. 2B shows an axial flux induction machine 100b according to a different embodiment, in which the machine 100b has multiple (e.g., three) stator-rotor sets 158a, 158b, 158c mounted on a common shaft 103b. Each stator-rotor set 158a, 158b, 158c includes two stators with a rotor in between that is similar to the axial flux induction machine 100 of FIGS. 1 and 2A. The stator-rotor sets 158a, 158b, 158c are stacked or attached to each other and work together to rotate the shaft 103b with increased force as compared to an axial flux induction machine without multiple stator-rotor sets.

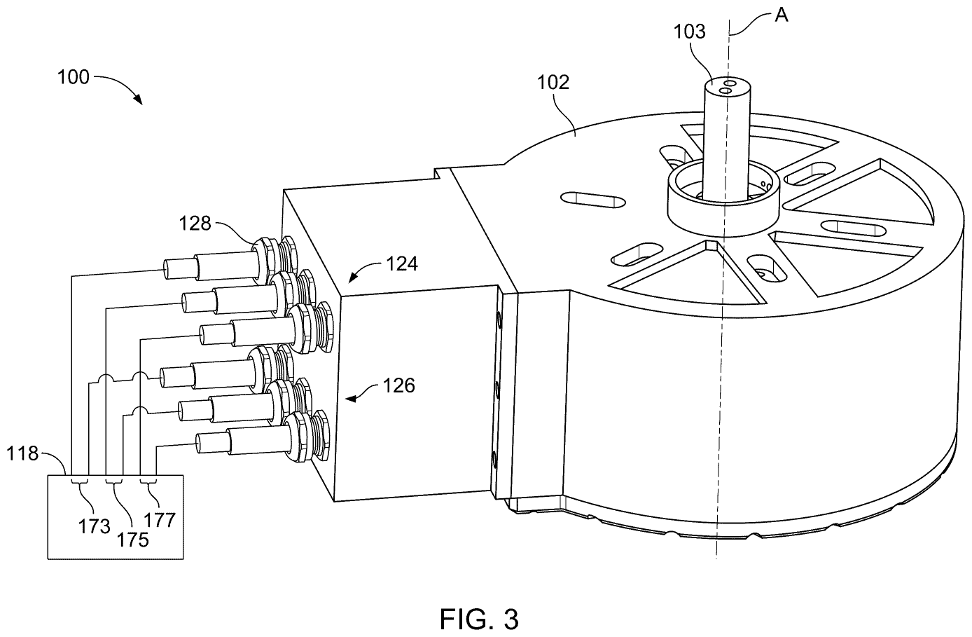

Referring also to FIG. 3, the axial flux induction machine 100 can also include an example control system 118 and two sets 124, 126 of terminals electrically coupled with the control system 118. Each set 124, 126 can be a set of three-phase terminals. In some implementations, each set 124, 126 has three terminals, one for each phase. In some implementations, the two sets 124, 126 of terminals are grouped in pairs 173, 175, 177 of terminals (and cables) each corresponding to one of the three phases. For example, the axial flux induction machine 100 has a pair 173 of first phase terminals and cables, a pair 175 of second phase terminals and cables, and a pair 177 of third phase terminals and cables. Each of the cables extend from the control system 118 to the terminals. The two sets 124, 126 of terminals can extend through a side of the housing 102. In some implementations, the two sets 124, 126 of terminals are attached with the housing using electrical fittings 128.

The control system 118 applies or transmits electrical power to the axial flux stators 104, 106 through the sets 124, 126 of terminals. The electrical power can include three phases. For example, the control system 118 applies three-phase AC voltages to the coil winding assemblies 112, 116, applying a single-phase voltage to each terminal. The rotor 108 has a magnetic body and conductive bodies (e.g., bodies that define conductive pathways), whereas the stators 104, 106 have electrical conductors and magnetic bodies. The magnetic body 300 is a body that can be magnetized (e.g., a metal with magnetic properties). The power supplied by the control system 118 sets up electric currents through the stators 104, 106 that create a series of rotating magnetic poles which move in circumferential direction and is static in axial direction. This develops an axial magnetic field that extends across the air gaps 136, 138 and through the rotor 108 to rotate the rotor 108 which rotates the shaft 103. In other words, each coil winding assembly 112, 116 allows an electric current to pass through the coil winding to generate an electromagnetic field in an axial direction (e.g., parallel to the axis of rotation “A” of the rotor 108) to rotate the rotor 108. Although the shaft 103 is shown as having a fluid inlet and outlet, the shaft 103 can be a solid shaft without fluid inlets and outlets.

The control system 118 can be implemented as a high voltage power inverter module system. In some implementations, the inverter system can include one or more processors and a computer-readable medium storing instructions executable by the one or more processors to perform the operations described here. In some implementations, the controller or control system 118 is implemented as processing circuitry, firmware, software, high voltage switching devices or combinations of them.

FIG. 4 shows each stator 104, 106 connected to respective example sets 120, 122 of terminal bus bars. Each set 120, 122 of terminal bus bars includes a first phase terminal bus bar 123, a second phase terminal bus bar 125, a third phase terminal bus bar 127, and a neutral terminal bus bar 129. The sets 120, 122 of terminal bus bars are electrically connected to the sets 124, 126 of electrical terminals shown in FIG. 3.

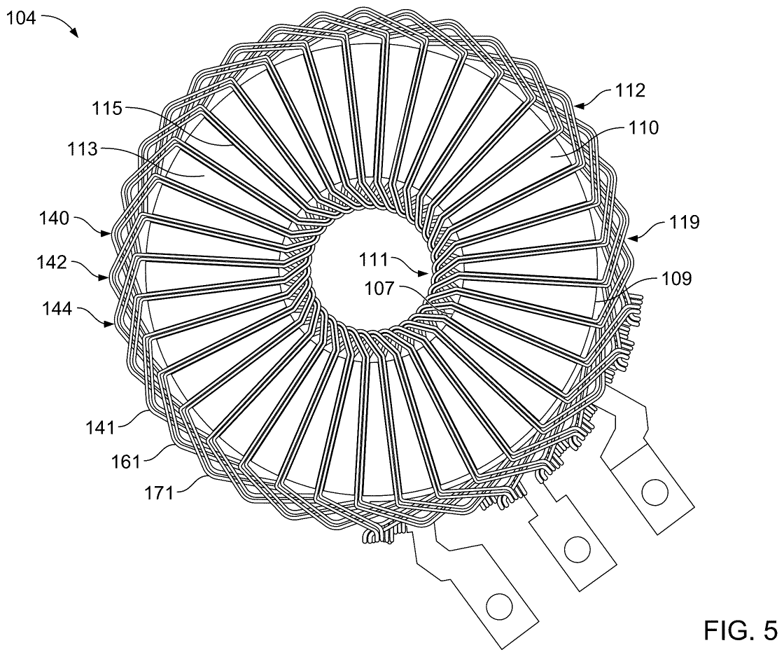

Referring also to FIG. 5, each stator core 110, 114 has multiple example stator teeth 113 and multiple slots 115 defined between each pair of consecutive stator teeth 113. FIG. 5 shows the first stator 104, but the second stator 106 is configured the same or substantially the same as the first stator 104. At least a portion of the coil winding assembly 112 resides within the slots 115 and around the stator teeth 113. The slots 115 extend radially from an inner surface 107 (e.g., an inner circumference) of the stator core 110 to an outer surface 109 (e.g., an outer circumference) of the stator core 110. The coil winding assembly 112 extends through each slot 115, forming an inner coil bundle 111 disposed at the inner surface 107 of the stator core 110 and an outer coil bundle 119 disposed at the outer surface 109 of the stator core 110.

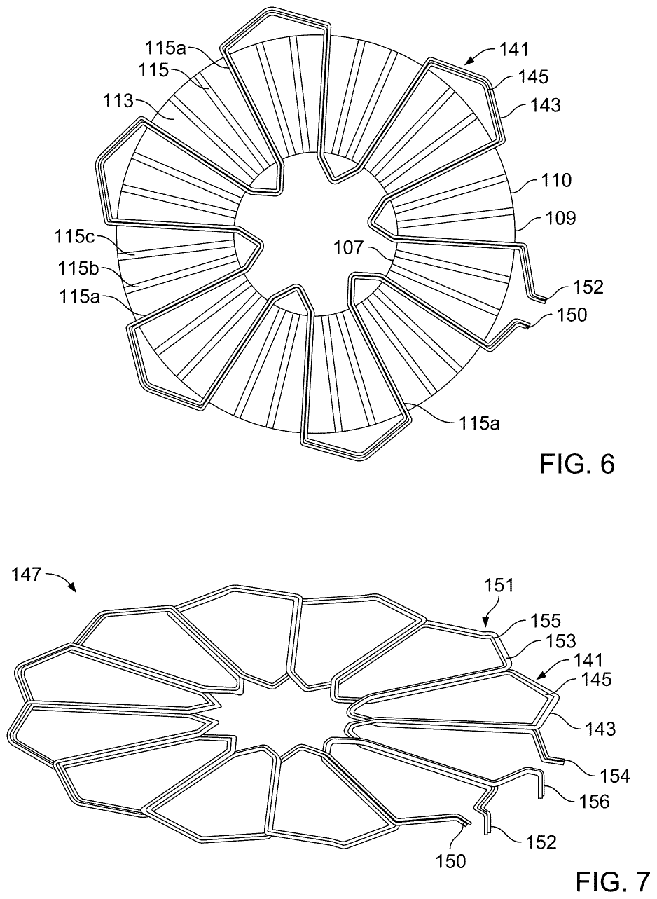

The coil winding assembly 112 has three overlapped coil subassemblies 140, 142, 144. The three coil subassemblies 140, 142, 144 include a first phase coil subassembly 140, a second phase coil subassembly 142, and a third phase coil subassembly 144. Referring also to FIGS. 6 and 7, each coil subassembly 140, 142, 144 is laid along a different set of slots 115 and overlaps one another to form an overlapped or interlocked winding. As shown, each coil subassembly 140, 142, 144 is made of coils arranged in a respective serpentine path through a respective group 115a, 115b, 115c of the slots 115. For example, the serpentine path can be a path winding through the slots 115, looping through the slots 115, or zigzagging through the slots 115. Each coil strand follows a respective serpentine path, with some following the same serpentine path. The coils can be formed as hair pinned round coil winding. In some implementations, each coil is a solid coil that is pre-formed or pre-shaped before assembly, and then placed on the stator along its respective serpentine path.

Each of the three overlapped coil subassemblies 140, 142, 144 are electrically isolated from each other. In some aspects, during operation of the motor, the first phase coil subassembly 140 has a first phase current, the second phase coil subassembly 142 has a second phase current, and the third phase coil subassembly 144 has a third phase current such that together, the three coil subassemblies 140, 142, 144 generate a balanced, three-phase current that generates a rotating magnetic field to rotate the rotor 108 to generate torque with the shaft 103 of the rotor 108.

FIGS. 6 and 7 show an example coil 141 (or coils) and coil set 147 of the first phase coil subassembly 140 arranged in a serpentine path. In some implementations, each of the three coil subassemblies 140, 142, 144 includes respective coils and coil sets as shown in FIGS. 6 and 7. As shown in FIG. 6, the first phase coil subassembly 140 is made of multiple coils 141 that extend continuously around the stator core 110 and are arranged in a first serpentine path through a first group 115a of slots of the multiple slots 115. As shown in FIG. 5, the second phase coil subassembly 142 also has one or more coil sets 161 arranged in a serpentine path through the second group 115b of slots, and the third phase coil subassembly 144 has one or more coils sets 171 arranged in a serpentine path through the third group 115c of slots.

As shown in FIG. 6, the serpentine path of each coil is such that the coil zigzags radially between the inner surface 107 and outer surface 109 of the stator core 110. The coil 141 extends continuously from a first end 150 to a second end 152 of the coil 141 around most or all of the circumference of the stator core 110. Each of the three coil subassemblies 140, 142, 144 (shown in FIG. 5) is laid in one third of the slots 115. For example, each group 115a, 115b, 115c of slots includes one third of the slots 115. As shown, the first group 115a includes each first slot of each three consecutive slots 115, the second group 115b of slots includes each second slot of each three consecutive slots 115, and the third group 115c of slots includes each third slot of each three consecutive slots 115. Thus, each of the three overlapped coil subassemblies 140, 142, 144 are mechanically and electrically arranged to have a different phase shift from one another. The larger the inner and the outer diameter of the stator core 110, the higher number of slots 115 (and slot width) it can be.

Thus, the second coil set 161 has a third coil (e.g., a third pair of conductor strands) arranged in the third serpentine path through the second group 115b of slots and a fourth coil (e.g., a fourth pair of conductor strands) arranged in a fourth serpentine path through the second group 115b of slots. The fourth serpentine path is offset with respect to the third serpentine path. Similarly, the third coil set 171 that has a fifth coil (e.g., a fifth pair of conductor strands) arranged in a fifth serpentine path through the third group 115c of slots and a sixth coil (e.g., a sixth pair of conductor strands) arranged in a sixth serpentine path through the third group 115c of slots. The sixth serpentine path is offset with respect to the fifth serpentine path.

As shown in FIG. 6, the first coil 141 can include a pair of conductor strands 143, 145. In some implementations, the two conductor strands 143, 145 are round conductor strands 143, 145 that extend parallel with respect to each other along the serpentine path. In some implementations, each conductor is formed from a polygonal (e.g., semi-rectangular or another polygonal cross section) wire strands.

In some implementations, the strands have a similar shape, length, and electrical resistivity, allowing the axial flux machine 100 to have a coil winding assembly 112 with a balanced parallel path. Each coil path can be assigned to a phase, in which the coil pitch is defined as min 3N, where N=1,2,3, . . . N. Moreover, the coil winding assembly 112 can have isolated neutrals. In some aspects, a three-phase balanced parallel path has three sets of electrically isolated coil sets uniformly distributed in stator slots around the stator with a specified pitch, where a pitch is proportional to the number of slot divided by the number of poles. In some aspects, isolated neutrals refers to the neutrals floating in space and being electrically isolated from the ground and any other bodies. Isolated neutrals can prevent the current circulation between parallel paths. For example, in an arrangement that includes a coil winding with two sets of three-phase parallel paths with a common one neutrals (instead of isolated neutrals), the electrical circulating current that forms between parallel paths can lead to power loss and average torque oscillation.

Moreover, the conductor strands 143, 145 are made of a conductive metal. In some implementations, the conductor strands are made of aluminum or copper. Thus, the winding assembly 112 can be made of uniformly conductive materials such as electrically insulated aluminum or copper.

Each conductor strand 143, 145 can be pre-shaped before installing the conductor strand 143, 145 in the stator core 110. In some implementations, the shape of the conductor strands 143, 145 is simple and substantially the same in the entire coil winding assembly 112, allowing each conductor strand 143, 145 (and by extension the coil winding assembly 112) to be shaped automatically (e.g., by a molding machine, a robot, etc.) and installed in the stator core 110 automatically. Moreover, each of the round, solid conductor strands of the winding 112 can have substantially the same length and resistance, simplifying the design and assembly of the winding 112.

In some implementations, each set of four coils has a start and an end that are connected to form a series turn. In some implementations, the position of each coil set in a slot changes in a specific way to avoid the coils to collide each other. In some aspects, a “turn” refers to each conductor in a slot. Moreover, a series turn refers to the conductor being connected in series with an adjunct conductor in an adjunct slot in the same slot. In contrast, a parallel path refers to the conductors being electrically connected in parallel.

FIG. 7 shows an example coil set 147 of the first phase coil subassembly 140. The coil set 147 includes the first coil 141 (e.g., coil pair 141) and a second coil 151 (e.g., coil pair 151). The first coil 141 has two conductor strands 143, 145 and the second coil 151 has two conductor strands 153, 155. Thus, each coil set 147 has four conductor strands 143, 145, 153, 155.

Each of the three coil subassemblies 140, 142, 144 (shown in FIG. 4) can be made of multiple coil sets. In some implementations, each of the three coil subassemblies 140, 142, 144 is made of six coil sets. Because each coil set includes four conductor strands, each coil subassembly 140, 142, 144 can be made of 24 conductor strands so that the entire coil winding assembly 112 of each stator is made of 72 conductor strands.

The coils 141, 151 of the coil set 147 can be arranged in opposite paths and interlocked or intertwined with each other. In some implementations, the first coil 141 is arranged in a first serpentine path through the first group 115a of slots, and the second coil 151 is arranged in a second serpentine path through the same group 115a of slots. The second serpentine path is offset with respect to the first serpentine path. In other words, the second coil 151 extends along the same slots as the first coil 141, but its serpentine path is opposite to the serpentine path of the first coil 141 so that its outer bends align radially with the inner bends of the first coil 141. Assembled, the first coil 141 has its ends 150, 152 next to the ends 154, 156 of the second coil 151.

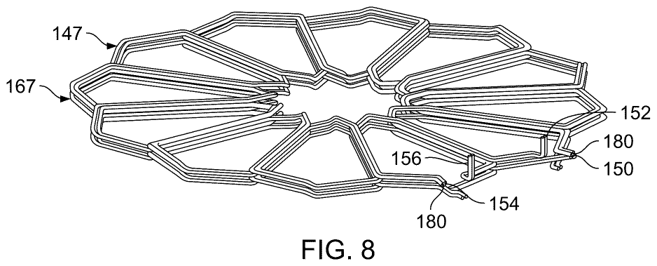

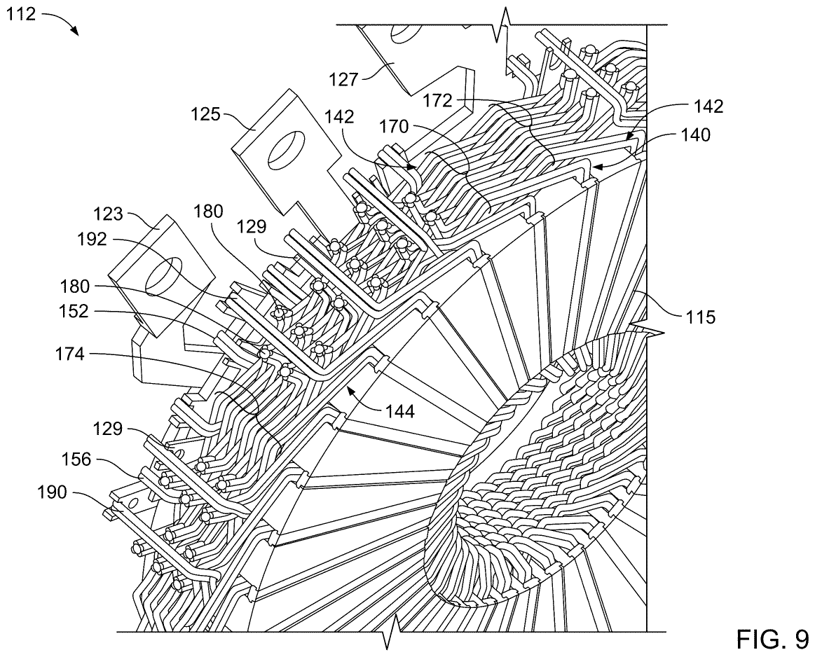

FIG. 8 shows two coil sets 147, 167 connected to each other. Each of the three coil subassemblies 140, 142, 144 can be made of stacked coil sets. For example, referring also to FIG. 9, the first phase coil subassembly 140 is made of a first stack 170 of coil sets, the second phase coil subassembly 142 is made of a second stack 172 of coil sets, and the third phase coil subassembly 144 is made of a third stack 174 of coil sets. The first stack 170 of coil sets includes the first coil set 147 and a group (e.g., five) of coil sets stacked on and electrically connected to the first coil set 147. Similarly, the second phase coil subassembly 142 and third phase coil subassembly 144 each include a stack of coil sets interconnected to one another.

In some implementations, the first stack 170 is electrically connected in parallel, the second stack 172 is electrically connected in parallel, and the first stack 170 is connected in series with the second stack 172. As shown, the coil sets of the first stack 170 are connected in parallel with one another, the coil sets of the second stack 172 are connected in parallel with one another, and the coil sets of the first stack 170 are connected in series with the coil sets of the second stack 172.

FIG. 9 shows the connection points 180 of each coil set. For example, the first phase coil subassembly 140 has multiple connection points 180 that each connect the end of four conductor strands. For example, as shown in FIG. 8, respective ends 150, 154 of the first coil set 147 are connected, through connection points 180, to the second coil set 167. The connection points can include weld joints 180 (e.g., weld points). In some implementations, the weld joints 180 form a continuous conductor such that a current can pass through the entire first phase coil subassembly 140 uninterruptedly. In some implementations, in total, there are 30 coil-coil weld joints per three-phase, with 14 weld joints per phase (including the joints to the bus bars) and 12 weld joints to bus bars and neutral. As shown in FIG. 9, the other two ends 152, 156 of the first coil set 147 extend vertically away from the second coil set 167 to connect to the neutral bus bar 129. The first phase coil subassembly 140 also has two terminal ends 190, 192 that extend from the top of the first stack 170 to connect to the first phase terminal bus bar 123. Similarly, two respective ends of each of the second and third phase coil subassemblies 142, 144 are connected to the neutral bus bar 129, and two respective terminal ends of each of the second and third phase coil subassemblies 142, 144 are connected to their respective second and third phase terminal bus bars 125, 127.

Such arrangement of the three coil subassemblies 140, 142, 144 result in the coil winding assembly 112 having a fill factor of between 55% and 75% (e.g., 65%). In some aspects, the fill factor refers to the percentage, in a cross-sectional view of a slot 115, of the area of the slot 115 that is filled by the coil winding 112.

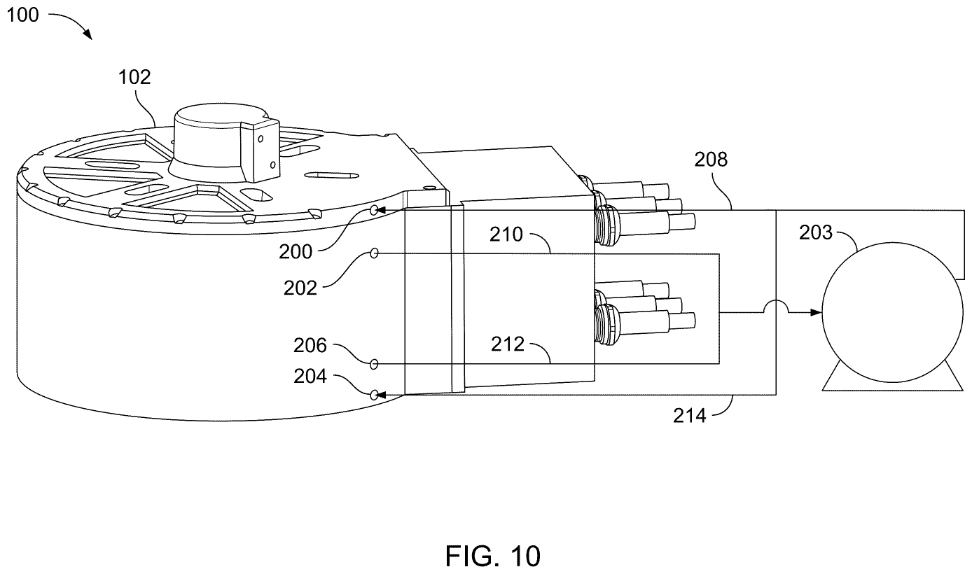

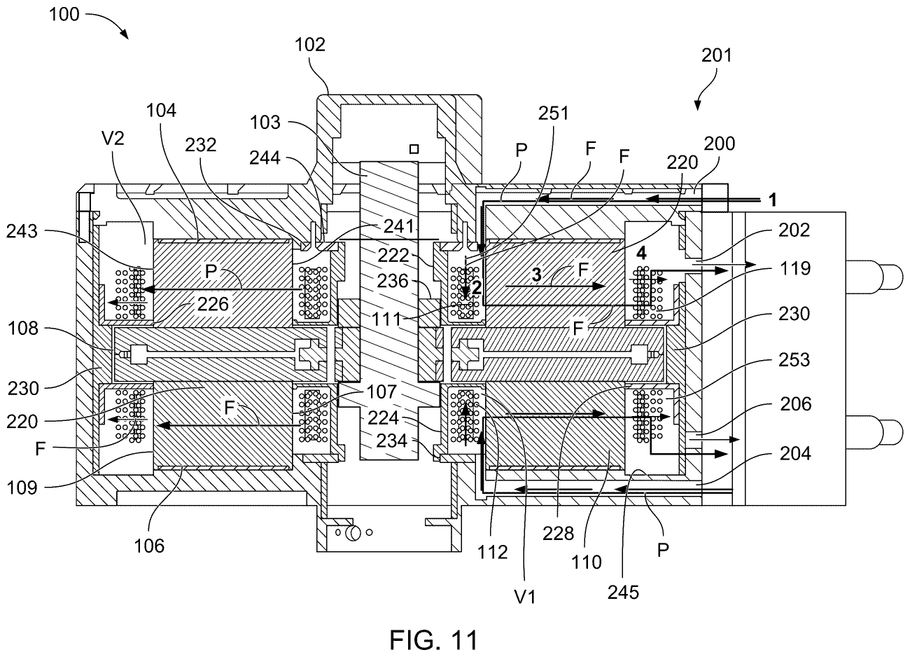

FIG. 10 shows the housing 102 of the axial flux induction machine 100 with cooling fluid ports 200, 202, 204, 206. The housing 102 can have two fluid inlets 200, 204, and two fluid outlets 202, 206. In some implementations, the first fluid inlet 200 and first fluid outlet 202 reside above the second fluid inlet 204 and the second fluid outlet 206. Referring also to FIG. 11, the first fluid inlet 200 and first fluid outlet 202 are fluidly coupled with the first stator 104 (e.g., the upper stator) and the second fluid inlet 204 and the second fluid outlet 206 are fluidly coupled with the second stator 106 (e.g., the lower stator).

The axial flux induction machine 100 can be fluidly coupled with an example fluid pump 203. In some implementations, the fluid pump 203 is fluidly coupled with the fluid inlets 200, 204 and the fluid outlets 202, 206. The fluid pump 203 flows the cooling fluid “F” into the fluid inlets 200, 204 and flows (or receives) the cooling fluid “F” out of the machine 100 (e.g., out of each stator core 110) through the fluid outlets 202, 206.

The cooling fluid “F” can be a liquid. In some implementations, the cooling fluid “F” is an oil or another type of dielectric fluid. In some aspects, the cooling fluid “F” can withstand high temperatures and is not magnetic. The pump 203 is fluidly coupled with the housing 102 through supply lines 208, 214 and return lines 210, 212. In some implementations, the pump 203 is a variable speed pump controlled by the control system 118 or a different controller to efficiently cool the stators of the induction machine 100. For example, the controller can vary the flow rate of the pump as a function of one or more parameters of the machine 100, such as temperature of the stators 104, 106, rotational speed of the rotor 108, etc.

FIG. 11 shows a cross-sectional view of the axial flux induction machine 100 with an example cooling system 201. The stator core 110 of each stator 104, 106 defines a cooling fluid flow path “P” through which the cooling fluid “F flows to cool the coil winding assembly 112 and stator core 110. Referring briefly to FIG. 17, each slot 115 of the stator core 110 defines a fluid conduit 220. Each fluid conduit 220 receives the cooling fluid “F” to cool the conductors of the stator winding assembly 112 disposed within the slots 115. Referring now to FIG. 11, each fluid conduit 220 extends from a fluid ingress 241 of each slot 115 to a fluid egress 243 of each slot 115. The fluid ingress 241 is fluidly coupled with the fluid inlet 200 (and 204) of the housing 102 and the fluid egress 243 is fluidly coupled with the fluid outlet 200 (and 206) of the housing 102. The fluid ingress 241 is at the inner surface or circumference of the stator core 110, and the fluid egress 243 is at the outer surface or circumference of the stator core 110.

The cooling fluid flow path “P” extends from the fluid inlet 200, 204 through the respective fluid conduits 220, and to the fluid outlet 202, 206. The coil winding assembly 112 is arranged in such a manner to allow the cooling fluid “F” to flow through the respective fluid conduits 220 to cool the coil winding assembly 112 and stator core 110 as the cooling fluid “F” flows along the cooling fluid flow path “P.”

The first fluid inlet 200 can include an inlet passage or conduit that extends above the upper stator 104 and the second fluid inlet 204 can be an inlet passage or conduit that extends below the lower stator 106. In some implementations, each cooling fluid inlet 200, 204 extends to and is fluidly coupled with an inner annular chamber 251. The inner annular chamber 251 is a ring-shaped housing defined between the shaft 103 and the inner surface 107 of the stator core 110. Similarly, each cooling fluid outlet 202, 206 is fluidly coupled with an outer annular chamber 253. The outer annular chamber 251 is a ring-shaped housing and resides at the outer surface 109 of the stator core 110.

Each inner annular chamber 251 defines an annular volume “V1” and each outer annular chamber 253 defines an annular volume “V2.” Each inner annular chamber 251 houses, within its volume “V1,” the inner coil bundle 111 or section of the respective coil winding assembly 112, 116, and each outer annular chamber 253 houses, within its volume “V2,” the outer coil bundle 119 of the respective coil winding assembly 112, 116. The bundles or sections 111, 119 of the coil winding assembly 112, 116 contain the bend points of the coil winding assembly 112, 116 and are disposed along the cooling fluid flow path “P.” The configuration of the coil winding assembly allows the winding volume of the inner coil bundle 111 (and outer coil bundle 119) to be reduced as compared to other axial flux machines.

The axial flux induction machine 100 also includes multiple seals 222, 224, 226, 228, 230, 232, 234, 236 (e.g., cooling guides) that contain the cooling fluid “F” within the cooling fluid flow path “P.” The multiple seals include two inner tubular cap seals 222, 224 (e.g., L-shaped seal plates) disposed about the shaft 103 and two outer tubular cap seals 226, 228 disposed about the outer section 119 of the coil winding 112. The multiple seals also include an outer seal cylinder 230, a first ceiling seal 232, a second ceiling seal 234, and a shaft seal 236.

All of the tubular cap seals 222, 224, 226, 228 can have an L-shape cross section. In some implementations, the inner tubular cap seals 222, 224 bear against and extend from the inner surface 107 of the stator core 110 to the ceiling seal 232 to fluidly isolate the coil winding 112 from the shaft 103. The outer tubular cap seals 226, 228 bear against and extend from the outer surface 109 of the stator core 110 to the outer seal cylinder 230 to fluidly isolate the coil winding 112 from the rotor 108.

The seal cylinder 230 is connected to the outer tubular cap seals 226 and fluidly isolate the stators 104, 106 from the outside of the housing 102. The annular volume “V1” of each inner annular chamber 251 is defined between the inner tubular cap seal 222, 224, the ceiling seal 232, 234, and the inner surface 107 of the stator core 110, 114. The annular volume “V2” of each outer annular chamber 253 is defined between the outer tubular cap seal 226, 228, the ceiling 245 of the housing 102, and the outer surface 109 of the stator core 110.

The annular volume “V1” is fluidly coupled with the inlet 200, 204 and the annular volume “V2” is fluidly coupled with the fluid outlet 202, 206. The fluid conduits 220 formed in each slot 115 are disposed between and fluidly coupled with the annular volumes “V1,” “V2” so that the cooling fluid flow path “P” extends from the inlet 200, 204 to the outlet 202, 206. The stator slots 115 extend radially from the inner surface 107 to the outer surface 109 so that each fluid ingress 2441 resides at the inner surface 107 and inner volume “V1” of the stator, and each fluid egress 243 resides at the outer surface 109 and the outer volume “V2” of the stator.

As the cooling fluid “F” flows along the cooling fluid flow path “P,” the cooling fluid “F” flows from the inlet conduit 200 into the inner annular chamber 251 to cool the inner section 111 of the coil winding assembly 112, 116. From the inner annular chamber 251, the cooling fluid “F” flows into the fluid conduits 220 to cool the section of the winding assembly 112, 116 that is disposed within the stator slots 115. From the fluid conduits 220, the cooling fluid “F” flows into the outer annular chamber 253 to cool the outer section 119 of the coil winding assembly 112, 116. From the outer annular chamber 253, the cooling fluid “F” flows out of the housing 102 through the fluid outlets 202, 206.

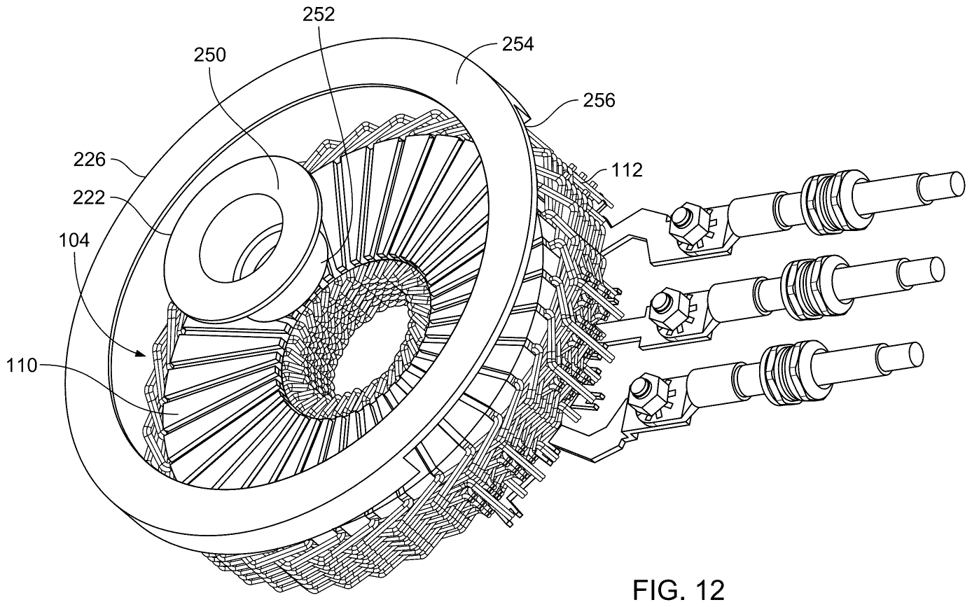

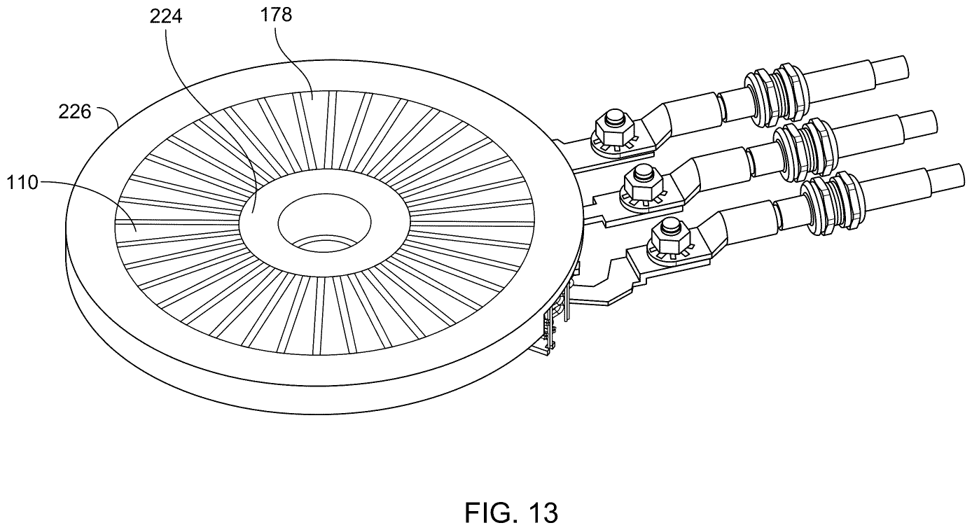

FIGS. 12 and 13 show the sequential steps of installing the inner tubular cap seal 222 and outer tubular cap seal 226 on a stator 104. The inner tubular cap seal 222 includes a base 250 and a sleeve 252 extending from the base 250. The sleeve 252 is inserted into the aperture formed by the inner section 111 of the coil winding assembly 112. The outer tubular cap seal 226 has a base 254 and a partial wall 256 extending from the base 254. The outer tubular cap seal 226 is positioned about the stator core 110 and the partial wall 256 defines a gap that receives the terminal bus bars of the stator 104. As shown in FIG. 12, to install the inner tubular cap seal 222 and outer tubular cap seal 226 on the stator 104, the inner tubular cap seal 222 and outer tubular cap seal 226 are inserted into the stator 104 from the same side of the stator 104. Thus, the inner diameter of the coil winding assembly 112 is encapsulated within two cap seals 222, 232 preventing the oil from entering the shaft and airgap area of the motor.

As shown in FIG. 13, when installed, the inner tubular cap seal 222 and outer tubular cap seal 226 can be flush or substantially flush with the upper surface 178 of the stator core 110. In some implementations, the inner tubular cap seal 222 and outer tubular cap seal 226 are designed to maintain the thickness of the stator 104 the same as without the cap seals 222, 226. Moreover, the inner tubular cap seal 222 and outer tubular cap seal 226 form a fluid tight seal with the stator core 110 to prevent fluid from leaking between the cap seals 222, 226 and the stator core 110.

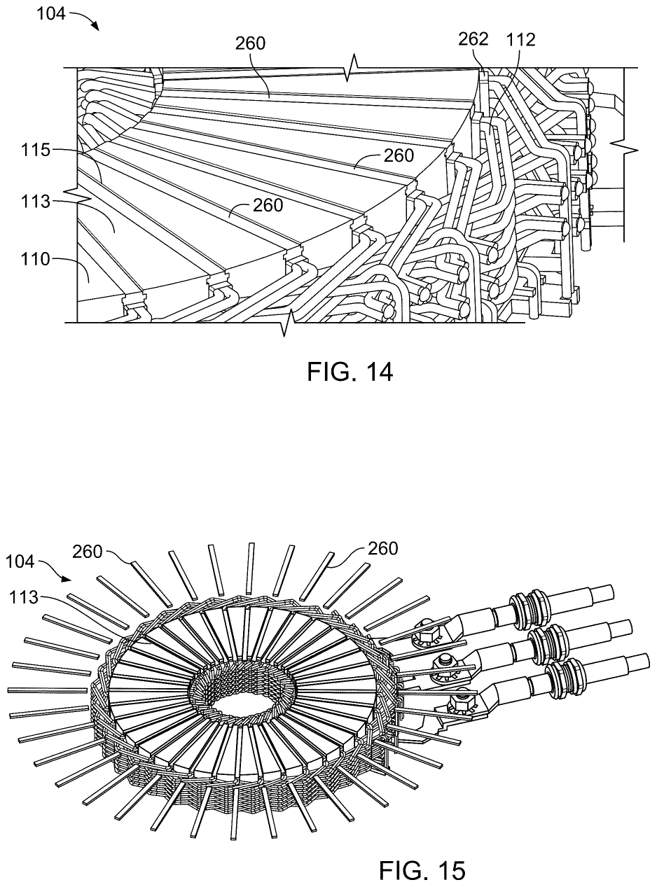

As shown in FIGS. 14 and 15, the core 110 of the stator 104 has multiple slot seals 260 at each slot 115. Each slot seal 260 is inserted into a respective stator slot 115 to fluidly enclose the top of each slot 115. Each slot seal 260 can spans a length of its respective slot 115 to fluidly isolate the respective slot 115 from the rotor. For example, the slot seals 260 prevent fluid from leaking out of the slots 115 into the top surface of the stator teeth 113, which faces the rotor. As shown in FIG. 14, each slot 115 can have sleeves 262 that span the length of the slots 115. The sleeves 262 can contain the section of the coil winding assembly 112 that is disposed within its respective slot 115. The sleeves 262 can also help fluidly isolate the slots 115 from the rotor.

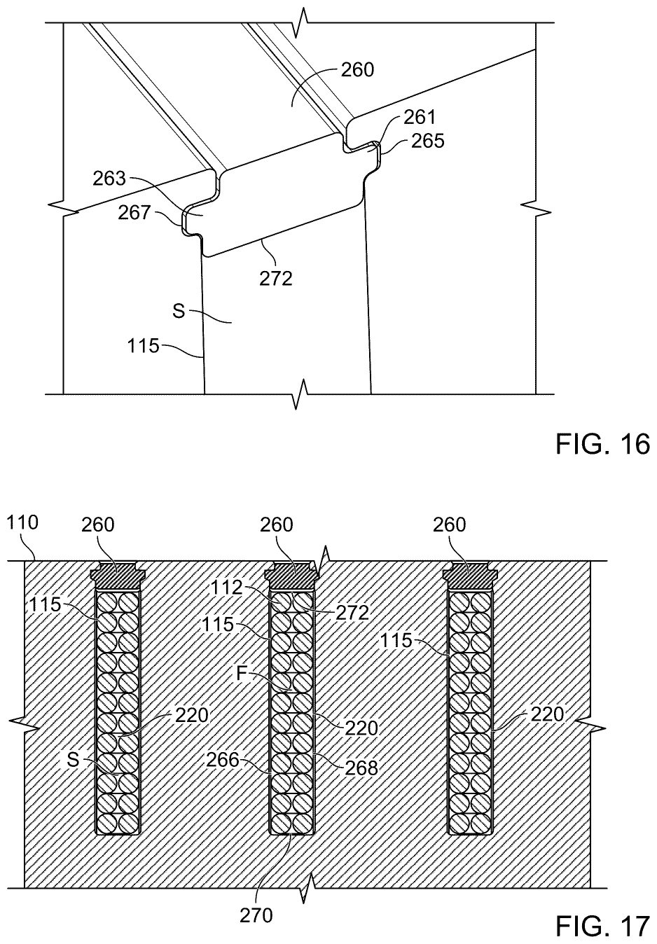

As shown in FIG. 15, each slot seal 260 can be inserted into its respective slot 115 from the outer surface of the stator core. For example, referring also to FIG. 16, each slot 115 has longitudinal notches 265, 267 that receive the slot seal 260 as the slot seal 260 is inserted into the slot 115. In some implementations, the slot seal 260 has longitudinal ribs 261, 263 that correspond with the notches 265, 267. Thus, each slot tooth 113 has a tip designed for radial assembly of the slot opening seals 260.

Referring also to FIG. 17, each slot 115 defines an example slot volume “S” defined between two parallel walls 266, 268, a slot floor 270, and a slot ceiling 272 of the slot 115. The longitudinal notches 265, 267 are each formed in a respective one of the parallel walls 266, 268 of the slots 115. The slot ceiling 272 is formed by a bottom surface of each slot seal 260. The cooling fluid “F” fills the slot volume “S” as the cooling fluid “F” flows along the cooling fluid flow path shown in FIG. 11. The coils of the coil winding assembly 112 are round coils/wires that from, between each coil, a gap therebetween through which the cooling fluid “F” can flow. In some aspects, “round” includes oval and other round-like shapes.

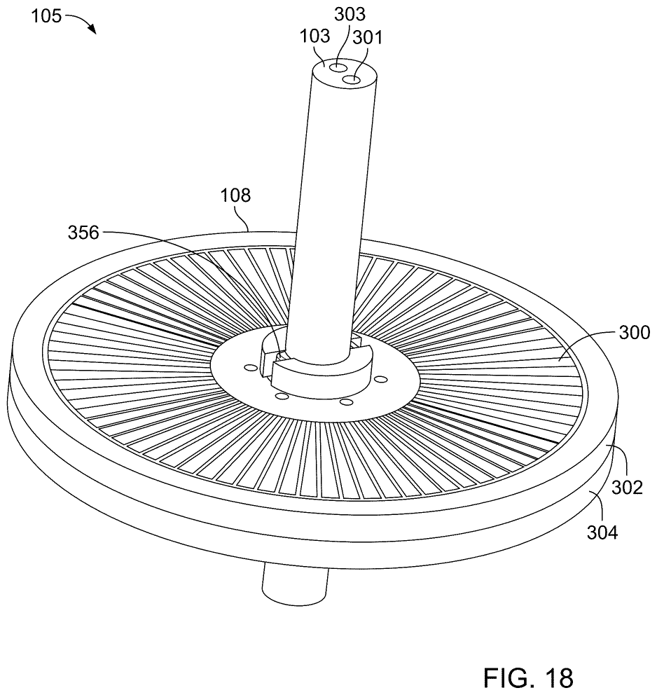

FIG. 18 shows an example axial flux rotor assembly 105. The rotor assembly includes the rotor 108 (e.g., a rotor disk 108) and shaft 103. The rotor 108 is coupled with (e.g., fixed to) the shaft 103. The rotor 108 is coupled with the shaft 103 (e.g., with mechanical fasteners) so that the shaft 103 rotates when the rotor 108 rotates. In some implementations, the rotor 108 is bolted on, welded on, or even integrally formed with or part of the shaft 103. In some implementations, the rotor 108 can be removed from the shaft 103 to maintain or replace parts of the rotor assembly 105.

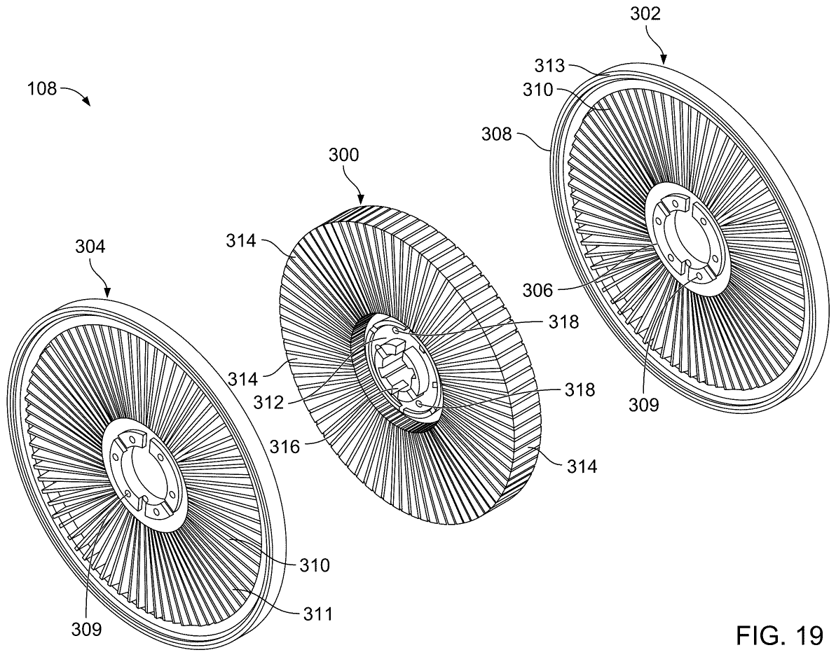

Referring also to FIG. 19, the rotor 108 includes a magnetic body 300 (e.g., a magnetic disk 300) and two conductive bodies 302, 304 (e.g., conductive disks 302, 304) interlocked with the magnetic body 300. In some implementations, the magnetic body 300 forms a magnetic path in the axial direction supported by magnetic material (e.g., magnetic steel material). In some implementations, the conductive bodies 302, 304 are nonmagnetic, and form and electrically conductive path supported by electrically conductive material (e.g., copper or aluminum) in the radial direction from the inner to the outer diameter of the rotor.

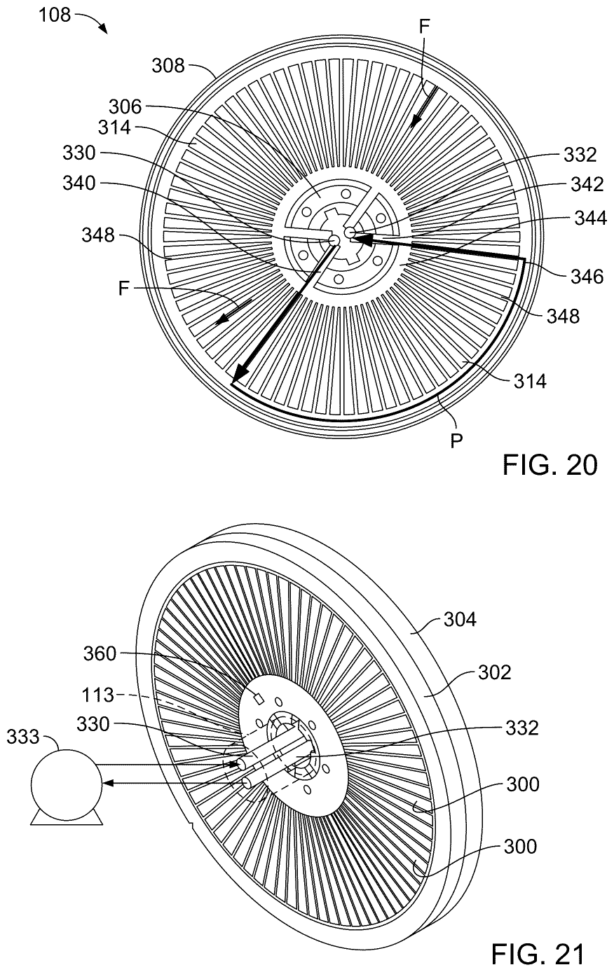

The shaft 103 includes a fluid inlet 301 and a fluid outlet 303. As further described in detail below with respect to FIGS. 20 and 21, the fluid inlet 301 and outlet 303 are fluidly coupled with fluid channels defined between the two conductive bodies 302, 304 to cool the rotor 108.

In some implementations, the magnetic body 300 is constructed primarily or entirely of ferromagnetic material and the two conductive bodies of 302, 304 are constructed of a diamagnetic and/or a conductive material. For example, the magnetic body 300 can be an integral (e.g., one-piece) body constructed of magnetic steel and the conductive bodies of 302, 304 can be integral (e.g., one-piece) bodies made of copper or aluminum. Thus, the axial flux induction machine is constructed without permanent magnets. These magnetic and conductive materials of the rotor 108 can, together, enhance the flux-carrying capacity of the rotor 108 and improve the electrical conductivity of the rotor 108 as compared to other axial flux machines, such as axial flux machines with permanent magnets.

Each conductive body 302 has an inner ring 306, an outer ring 308, and multiple bars 310 spaced by gaps 311 and extending radially between and attached to the inner ring 306 and outer ring 308 (similar to a bike tire). In some implementations, the inner ring 306 connects all of the conductive paths in the inner diameter of the cylinder and the outer ring 308 connects all of the conductive paths in the outer diameter of the cylinder. In some implementations, the outer ring 308 has an annular groove 313 that receives an annular rib of the other conductive body 302 to form a tight fitting and a seal. In some aspects, the annular groove 313 is in both conductive bodies 302, 304 and a seal ring is disposed between he grooves to form a fluid seal.

As shown in FIG. 18, the magnetic body 300 is coupled with the shaft 103. The magnetic body 300 is also disposed between and is interlocked (in the axial and radial direction) with the first conductive body 302 and the second conductive body 302. Thus, the conductive bodies 302, 304 are coupled with the shaft 103 through the magnetic body 300.

The magnetic body 300 has an inner body 312 (e.g., a flange or plate 312) and multiple radial liners 314 extending from the inner body 312. When assembled, the radial liners 314 are each disposed within the gaps 311 of the two conductive bodies 302, 304. The bars 310 have a width such that, when assembled with the magnetic body 300, the bars 310 of the first conductive body 302 do not touch the bars 310 of the second conductive body 304 so as to form, gaps between each pair of facing bars 310. As shown in FIG. 20, such gaps form fluid conduits 348 that extend from an inner annular conduit 344 to an outer annular conduit 346.

Each fluid conduit 348 is enclosed between two consecutive liners 314 and two bars 310 facing each other. In other words, each fluid conduit 348 extends along and between each of bar 310. Moreover, each fluid conduit 348 is fluidly coupled with the shaft 103 and extends radially from the inner rings 306 of the conductive bodies 302, 304 to the outer rings 308 of the conductive bodies 302, 304.

The inner ring 306 of each conductive body 302, 304 can act as coupling inner bodies so that they sandwich the inner ring 312 of the magnetic body 300 to attach the magnetic body 300 to the first and second conductive bodies 302, 304. As shown in FIG. 19, the two conductive bodies 302, 304 can be attached to the magnetic body 300 with mechanical fasteners that extend through apertures 309, 318.

As shown in FIG. 21, the shaft 103 can have fluid conduits 330, 332 that extend from the fluid ports 301, 303 (shown in FIG. 18). In some implementations, the fluid conduits 330, 332, include an inlet conduit 330 and an outlet conduit 332 both fluidly coupled with a fluid pump 333. The pump 333 can be the same or a different pump than the pump 203 of the stators. The inlet conduit 330 receives cooling fluid from the pump 333 and the pump 333 receives the cooling fluid from the outlet conduit 332. The pump 333 can be coupled with the shaft 103 through a rotational fluid coupling. In some implementations, the pump 333 is a variable speed pump configured to change a flow rate of the cooling fluid “F” as a function of a speed (or another parameter such as pressure or temperature) of the axial flux rotor. For example, the pump 333 can be controlled by the controller 118 shown in FIG. 3 (or a different controller) that receives sensor feedback from one or more sensors 360 that detect one or more parameter of the rotor such as the rotational speed of the rotor.

As shown in FIG. 20, the inlet conduit 330 and outlet conduit 332 are fluidly coupled with two inlet conduits 340 or passages of the rotor 108, and the outlet conduit 332 is fluidly coupled with two outlet conduits 342 or passages of the rotor 108. The inlet and outlet conduits 340, 342 form, with the rotor conduits 348 and the outer conduit 346, a fluid flow path “p.” The fluid flow path “p” extends from the inlet conduit 330 to the rotor inlet conduits 340, from the rotor inlet conduits 340 to the rotor conduits 348, from the rotor conduit 348 to the outer conduit 346. The fluid flow path “p” returns to the shaft 103 by extending from the outer conduit 346 to the rotor conduits 348, from the rotor conduits 348 to the outlet conduits 348, and from the outlet conduits 348 to the outlet conduit 332 of the shaft 103. As the rotor 108 rotates, the centrifugal force of the rotor 108 can distribute cooling fluid “F” along the entire annular conduits 344, 246 and all of the rotor conduits 348. The inlet and outlet conduits 340, 342, the rotor conduits 348, and the annular conduits 344, 246 are formed between the magnetic body 300 and a respective one of the conductive bodies 304. Thus, the rotor has inlet and outlet conduits 340, 342 and annular conduits 344, 246 on both sides of the magnetic body 300.

As shown in FIG. 21, the magnetic body 300 can form, with the first conductive body 302, a first side surface 350 that faces the first stator. The magnetic body 300 can also form, with the second conductive body 302, a second side surface 352 that faces the second stator. For example, when assembled, the external surface of the magnetic body 300 can be flush or substantially flush with the external surfaces of the conductive bodies 302, 304. In some implementations, the first side surface 350 and second side surface 352 are electroplated to fluidly isolate the rotor conduits from the stators.

As shown in FIGS. 18 and 20, the magnetic body 300 has pilot notches 354 that receive and engage with ribs 356 of the shaft 103. This allows the fluid conduits of the shaft to be aligned with the inlet and outlet fluid conduits of the rotor 108. In some aspects, the shaft 103 is fixed or integrally formed with the rotor 108.

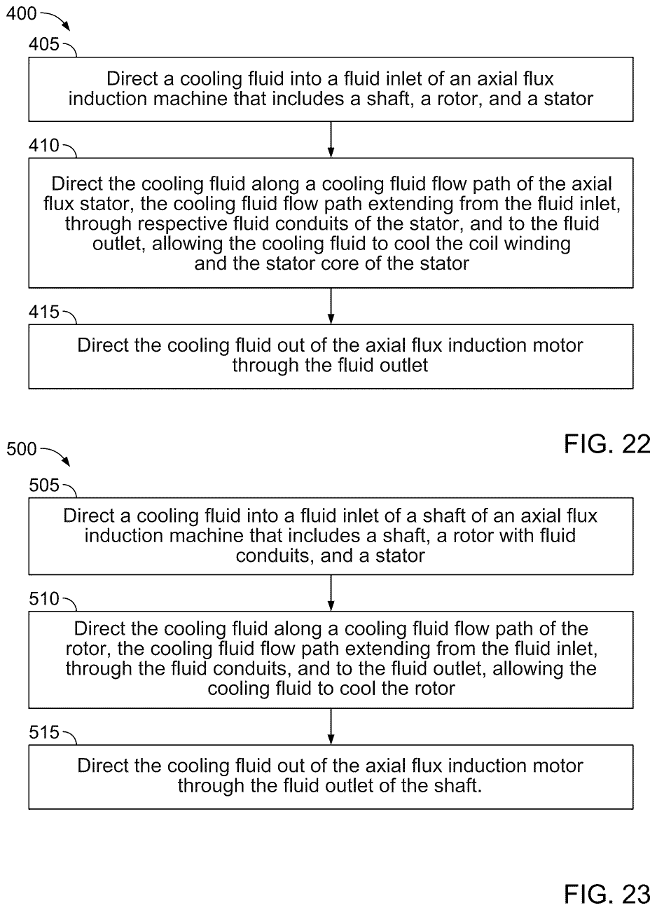

FIG. 22 is a flow chart of an example of a method 400 of cooling an axial flux stator (e.g., the axial flux stator 104, 106 in FIG. 1). The method includes directing a cooling fluid into a fluid inlet of an axial flux induction machine (405). The axial flux induction machine can be the same axial flux induction machine 100 shown in FIG. 1, which includes a housing, a shaft, an axial flux stator, and an axial flux rotor. The method also includes directing the cooling fluid along a cooling fluid flow path of the axial flux stator (410). The cooling fluid flow path extends from the fluid inlet, through the respective fluid conduits, and to the fluid outlet, allowing the cooling fluid to cool the coil winding and the stator core of the stator. The method also includes directing the cooling fluid out of the axial flux induction motor through the fluid outlet (415).

FIG. 23 is a flow chart of an example of a method 500 of cooling an axial flux rotor (e.g., the axial flux rotor 108 in FIG. 1). The method includes directing a cooling fluid into a fluid inlet of a shaft of an axial flux induction machine (505). The axial flux induction machine can be the same axial flux induction machine 100 shown in FIG. 1, which includes a housing, a shaft, an axial flux stator, and an axial flux rotor. The method also includes directing the cooling fluid along a cooling fluid flow path of the axial flux rotor. (510). The cooling fluid flow path extends from the fluid inlet, through the plurality of fluid conduits, and to the fluid outlet, allowing the cooling fluid to cool the axial flux rotor. The method also includes directing the cooling fluid out of the axial flux induction motor through the fluid outlet of the shaft (515).

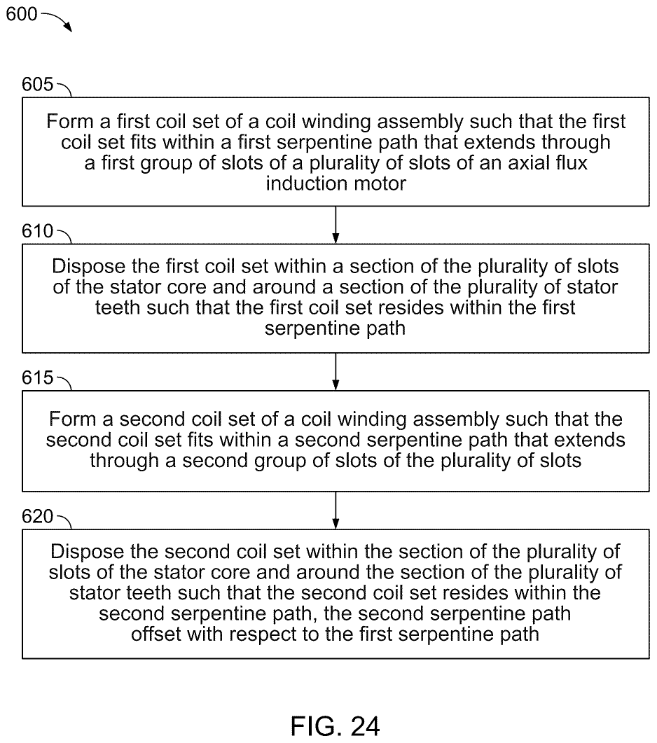

FIG. 24 is a flow chart of an example of a method 600 of installing a coil winding in a core of an axial flux stator (e.g., the axial flux stator 104, 106 in FIG. 1). The axial flux stator can be part of an axial flux induction machine such as the machine 100 shown in FIG. 1, which includes a housing, a shaft, an axial flux stator, and an axial flux rotor. The method includes forming a first coil set of a coil winding assembly such that the first coil set fits within a first serpentine path that extends through a first group of slots of a plurality of slots of the axial flux induction motor (605). The method also includes disposing the first coil set within a section of the plurality of slots of the stator core and around a section of the plurality of stator teeth such that the first coil set resides within the first serpentine path (610). The method also includes forming a second coil set of a coil winding assembly such that the second coil set fits within a second serpentine path that extends through a second group of slots of the plurality of slots (615). The method also includes disposing the second coil set within the section of the plurality of slots of the stator core and around the section of the plurality of stator teeth such that the second coil set resides within the second serpentine path, the second serpentine path offset with respect to the first serpentine path (620).

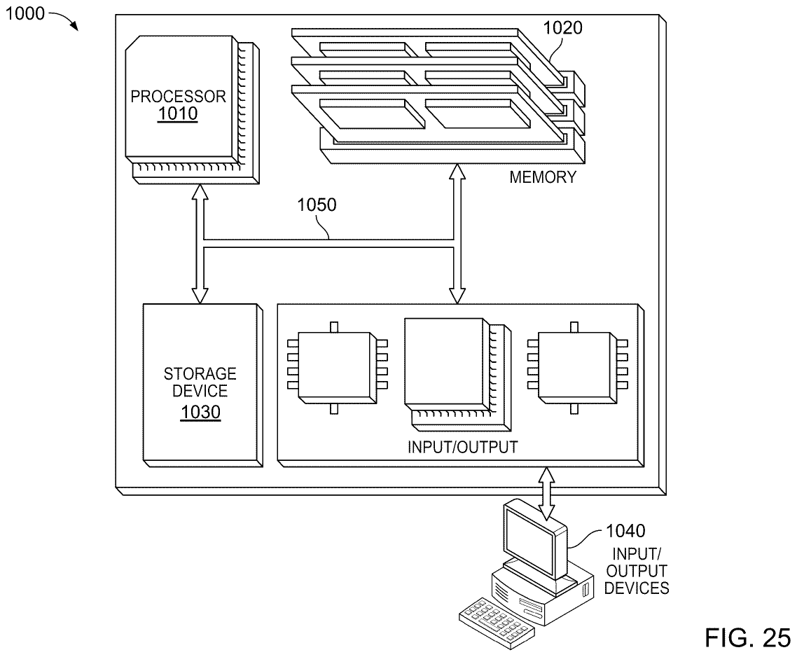

FIG. 25 is a schematic illustration of an example control system or controller for an axial flux induction machine according to the present disclosure. For example, the controller 1000 may include or be part of the controller 118 shown in FIG. 3. The controller 1000 is intended to include various forms of digital computers, such as printed circuit boards (PCB), processors, digital circuitry, or otherwise. Additionally, the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The controller 1000 includes a processor 1010, a memory 1020, a storage device 1030, and an input/output device 1040. Each of the components 1010, 1020, 1030, and 1040 are interconnected using a system bus 1050. The processor 1010 is capable of processing instructions for execution within the controller 1000. The processor may be designed using any of a number of architectures. For example, the processor 1010 may be a CISC (Complex Instruction Set Computers) processor, a RISC (Reduced Instruction Set Computer) processor, or a MISC (Minimal Instruction Set Computer) processor.

In one implementation, the processor 1010 is a single-threaded processor. In another implementation, the processor 1010 is a multi-threaded processor. The processor 1010 is capable of processing instructions stored in the memory 1020 or on the storage device 1030 to display graphical information for a user interface on the input/output device 1040.

The memory 1020 stores information within the controller 1000. In one implementation, the memory 1020 is a computer-readable medium. In one implementation, the memory 1020 is a volatile memory unit. In another implementation, the memory 1020 is a non-volatile memory unit.

The storage device 1030 is capable of providing mass storage for the controller 1000. In one implementation, the storage device 1030 is a computer-readable medium. In various different implementations, the storage device 1030 may be a floppy disk device, a hard disk device, an optical disk device, or a tape device.

The input/output device 1040 provides input/output operations for the controller 1000. In one implementation, the input/output device 1040 includes a keyboard and/or pointing device. In another implementation, the input/output device 1040 includes a display unit for displaying graphical user interfaces.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

A number of implementations have been described. Nevertheless, it will be understood that various modifications may be made without departing from the spirit and scope of the disclosure. For example, example operations, methods, or processes described herein may include more steps or fewer steps than those described. Further, the steps in such example operations, methods, or processes may be performed in different successions than that described or illustrated in the figures. Accordingly, other implementations are within the scope of the following claims.

### EXAMPLES

In an example implementation, an axial flux stator includes a stator core and a coil winding assembly. The stator core is disposed within and coupled with a housing of an axial flux induction machine and has a plurality of stator teeth and a plurality of slots defined between each pair of consecutive stator teeth. The coil winding assembly is disposed within the multiple slots and around the plurality of stator teeth. The coil winding assembly allows an electric current to pass through the coil winding assembly to generate an electromagnetic field in an axial direction with respect to a rotor disposed within the housing to rotate the rotor. The coil winding assembly has three overlapped coil subassemblies including a first phase coil subassembly, a second phase coil subassembly, and a third phase coil subassembly. Each of the three overlapped coil subassemblies has one or more coils extending continuously around the stator core and arranged in a respective serpentine path through a respective group of slots of the plurality of slots.

In an example implementation combinable with any other example implementation, the first phase coil subassembly includes a first coil set, the second phase coil subassembly includes a second coil set, and the third phase coil subassembly includes a third coil set. The first coil set includes a first pair of conductor strands arranged in a first serpentine path through a first group of slots of the plurality of slots and a second pair of conductor strands interlocked with the first pair of conductor strands and arranged in a second serpentine path through the first group of slots. The second serpentine path is offset with respect to the first serpentine path.

In an example implementation combinable with any other example implementation, the second coil set includes a third pair of conductor strands arranged in a third serpentine path through a second group of slots of the plurality of slots and a fourth pair of conductor strands arranged in a fourth serpentine path through the second group of slots. The fourth serpentine path is offset with respect to the third serpentine path, and the third coil set includes a fifth pair of conductor strands arranged in a fifth serpentine path through a third group of slots of the plurality of slots and a sixth pair of conductor strands arranged in a sixth serpentine path through the third group of slots. The sixth serpentine path is offset with respect to the fifth serpentine path.

In an example implementation combinable with any other example implementation, the first group of slots includes each first slot of each three consecutive slots of the plurality of slots. The second group of slots includes each second slot of each three consecutive slots of the plurality of slots, and the third group of slots includes each third slot of each three consecutive slots of the plurality of slots such that each of the three overlapped coil subassemblies are mechanically and electrically arranged to have a different phase shift from one another.

In an example implementation combinable with any other example implementation, the first pair of conductor strands includes two round conductor strands extending parallel with respect to each other along the first serpentine path, and the second pair of conductor strands includes two round conductor strands extending parallel with respect to each other along the second serpentine path.

In an example implementation combinable with any other example implementation, the first phase coil subassembly includes a first stack of coil sets including the first coil set and a first plurality of coil sets electrically connected to the first coil set. The second phase coil subassembly includes a second stack of coil sets including the second coil set and a second plurality of coil sets electrically connected to the second coil set. The third phase coil subassembly includes a third stack of coil sets including the third coil set and a third plurality of coil sets electrically connected to the third coil set.

In an example implementation combinable with any other example implementation, the first stack is electrically connected in parallel, the second stack is electrically connected in parallel, and the first stack is electrically connected in series with the second stack.

In an example implementation combinable with any other example implementation, each coil set of the first plurality of coil sets are welded to each other and to the first coil set, each weld point joining a parallel pair of conductor strands of one of the first plurality of coil sets to a parallel pair of conductor strands of a subsequent one of the first plurality of coil sets.

In an example implementation combinable with any other example implementation, the first pair of conductor strands includes a first end electrically coupled with a subsequent pair of conductor strands and a second end electrically coupled with a first phase terminal. The second pair of conductor strands includes a first end electrically coupled with a subsequent pair of conductor strands and a second end electrically coupled with the first phase terminal. Am end of the first phase coil subassembly is electrically coupled with a neutral terminal. In an example implementation combinable with any other example implementation, the second phase coil subassembly includes a first end electrically coupled with a second phase terminal and a second end electrically coupled with the neutral terminal, and the third phase coil subassembly includes a first end electrically coupled with a third phase terminal and a second end electrically coupled with the neutral terminal.

In an example implementation combinable with any other example implementation, the coil winding assembly includes a solid, pre-shaped, hair pinned round coil winding.

In an example implementation combinable with any other example implementation, the coil winding assembly includes at least one of aluminum or copper.

In an example implementation combinable with any other example implementation, a fill factor of the coil winding assembly is between 55% and 75%.

In an example implementation combinable with any other example implementation, each of the three overlapped coil subassemblies are electrically isolated from one another.

In an example implementation combinable with any other example implementation, the first phase coil subassembly is arranged to have a first phase current. The second phase coil subassembly is arranged to have a second phase current, and the third phase coil subassembly is arranged to have a third phase current such that together, the three overlapped coil subassemblies generate a balanced three-phase current that generates a rotating magnetic field to rotate the rotor to generate torque with the rotor.

In another example implementation, an axial flux induction machine includes a housing, a shaft, a first axial flux stator, a second axial flux stator, and an axial flux rotor. The shaft is rotatably coupled with the housing. The first axial flux stator is coupled with and disposed within the housing. The second axial flux stator is coupled with and disposed within the housing. The axial flux rotor is disposed within the housing and resides between the first and second axial flux stators. The axial flux rotor is coupled with the shaft and is rotatable with respect to the first and second axial flux stators. Each of the first and second axial flux stators includes a stator core and a coil winding. The stator core includes a plurality of stator teeth and a plurality of slots defined between each pair of consecutive stator teeth of the plurality of stator teeth. The coil winding assembly is disposed within the plurality of slots and around the plurality of stator teeth. The coil winding assembly includes three overlapped coil subassemblies including a first phase coil subassembly, a second phase coil subassembly, and a third phase coil subassembly. Each of the three overlapped coil subassemblies includes one or more coils extending continuously around the stator core and arranged in a respective serpentine path through a respective group of slots of the plurality of slots.

In an example implementation combinable with any other example implementation, the first phase coil subassembly includes a first coil set, the second phase coil subassembly includes a second coil set, and the third phase coil subassembly includes a third coil set. The first coil set includes a first pair of conductor strands arranged in a first serpentine path through a first group of slots of the plurality of slots and a second pair of conductor strands interlocked with the first pair of conductor strands and arranged in a second serpentine path through the first group of slots. The second serpentine path is offset with respect to the first serpentine path.

In an example implementation combinable with any other example implementation, the first pair of conductor strands includes two round conductor strands extending parallel with respect to each other along the first serpentine path, and the second pair of conductor strands includes two round conductor strands extending parallel with respect to each other along the second serpentine path.

In an example implementation combinable with any other example implementation, the first phase coil subassembly includes a first stack of coil sets including the first coil set and a first plurality of coil sets electrically connected to the first coil set. The second phase coil subassembly includes a second stack of coil sets including the second coil set and a second plurality of coil sets electrically connected to the second coil set, and the third phase coil subassembly includes a third stack of coil sets including the third coil set and a third plurality of coil sets electrically connected to the third coil set.

In an example implementation combinable with any other example implementation, the coil winding assembly includes a fill factor of between 55% and 75%.

In an example implementation combinable with any other example implementation, the axial flux induction machine further includes a control system electrically coupled with and configured to transmit power to the first and second axial flux stators. The power including three phases.

In another example implementation, a method of installing a solid coil winding in an axial flux motor stator includes forming a first coil set of a coil winding assembly such that the first coil set fits within a first serpentine path that extends through a first group of slots of a plurality of slots of a stator core of an axial flux induction motor. The stator core includes a plurality of stator teeth and the plurality of slots are defined between each pair of consecutive stator teeth of the plurality of stator teeth. The method also include disposing the first coil set within a section of the plurality of slots of the stator core and around a section of the plurality of stator teeth such that the first coil set resides within the first serpentine path. The method also includes forming a second coil set of a coil winding assembly such that the second coil set fits within a second serpentine path that extends through a second group of slots of the plurality of slots. The method also includes disposing the second coil set within the section of the plurality of slots of the stator core and around the section of the plurality of stator teeth such that the second coil set resides within the second serpentine path. The second serpentine path is offset with respect to the first serpentine path.

In an example implementation combinable with any other example implementation, disposing the first coil set and second coil set includes disposing a first phase coil subassembly within the section of the plurality of slots. The method further includes disposing a second phase coil subassembly within a second set of the plurality of slots and disposing a third phase coil subassembly within a third set of the plurality of slots such that the first, second, and third phase coil subassemblies are interlocked with one another.

What is claimed is:

1. An axial flux stator, comprising:
a stator core configured to be disposed within and coupled with a housing of an axial flux induction machine, the stator core comprising a plurality of stator teeth and a plurality of slots defined between each pair of consecutive stator teeth of the plurality of stator teeth; and
a coil winding assembly disposed within the plurality of slots and around the plurality of stator teeth, the coil winding assembly configured to allow an electric current to pass through the coil winding assembly to generate an electromagnetic field in an axial direction with respect to a rotor disposed within the housing to rotate the rotor,
wherein the coil winding assembly comprises three overlapped coil subassemblies comprising a first phase coil subassembly, a second phase coil subassembly, and a third phase coil subassembly, each of the three overlapped coil subassemblies comprising one or more coils extending continuously around the stator core and arranged in a respective serpentine path through a respective group of slots of the plurality of slots.

2. The axial flux stator of claim 1, wherein the first phase coil subassembly comprises a first coil set, the second phase coil subassembly comprises a second coil set, and the third phase coil subassembly comprises a third coil set, the first coil set comprising a first pair of conductor strands arranged in a first serpentine path through a first group of slots of the plurality of slots and a second pair of conductor strands interlocked with the first pair of conductor strands and arranged in a second serpentine path through the first group of slots, the second serpentine path offset with respect to the first serpentine path.

3. The axial flux stator of claim 2, wherein the second coil set comprises a third pair of conductor strands arranged in a third serpentine path through a second group of slots of the plurality of slots and a fourth pair of conductor strands arranged in a fourth serpentine path through the second group of slots, the fourth serpentine path offset with respect to the third serpentine path, and the third coil set comprises a fifth pair of conductor strands arranged in a fifth serpentine path through a third group of slots of the plurality of slots and a sixth pair of conductor strands arranged in a sixth serpentine path through the third group of slots, the sixth serpentine path offset with respect to the fifth serpentine path.

4. The axial flux stator of claim 3, wherein the first group of slots comprises each first slot of each three consecutive slots of the plurality of slots, the second group of slots comprises each second slot of each three consecutive slots of the plurality of slots, and the third group of slots comprises each third slot of each three consecutive slots of the plurality of slots such that each of the three overlapped coil subassemblies are mechanically and electrically arranged to have a different phase shift from one another.

5. The axial flux stator of claim 2, wherein the first pair of conductor strands comprises two round conductor strands extending parallel with respect to each other along the first serpentine path, and the second pair of conductor strands comprises two round conductor strands extending parallel with respect to each other along the second serpentine path.

6. The axial flux stator of claim 2, wherein the first phase coil subassembly comprises a first stack of coil sets comprising the first coil set and a first plurality of coil sets electrically connected to the first coil set, the second phase coil subassembly comprises a second stack of coil sets comprising the second coil set and a second plurality of coil sets electrically connected to the second coil set, and the third phase coil subassembly comprises a third stack of coil sets comprising the third coil set and a third plurality of coil sets electrically connected to the third coil set.

7. The axial flux stator of claim 6, wherein the first stack is connected in parallel, the second stack is connected in parallel, and the first stack is connected in series with the second stack.

8. The axial flux stator of claim 6, wherein each coil set of the first plurality of coil sets are welded to each other and to the first coil set, each weld point joining a parallel pair of conductor strands of one of the first plurality of coil sets to a parallel pair of conductor strands of a subsequent one of the first plurality of coil sets.

9. The axial flux stator of claim 2, wherein the first pair of conductor strands comprises a first end electrically coupled with a subsequent pair of conductor strands and a second end electrically coupled with a first phase terminal, and the second pair of conductor strands comprises a first end electrically coupled with a subsequent pair of conductor strands and a second end electrically coupled with the first phase terminal, and an end of the first phase coil subassembly is electrically coupled with a neutral terminal.

10. The axial flux stator of claim 9, wherein the second phase coil subassembly comprises a first end electrically coupled with a second phase terminal and a second end electrically coupled with the neutral terminal, and the third phase coil subassembly comprises a first end electrically coupled with a third phase terminal and a second end electrically coupled with the neutral terminal.

11. The axial flux stator of claim 1, wherein the coil winding assembly comprises a solid, pre-shaped, hair pinned round coil winding.

12. The axial flux stator of claim 1, wherein the coil winding assembly comprises at least one of aluminum or copper.

13. The axial flux stator of claim 1, wherein a fill factor of the coil winding assembly is between 55% and 75%.

14. The axial flux stator of claim 1, wherein each of the three overlapped coil subassemblies are electrically isolated from one another.

15. The axial flux stator of claim 1, wherein the first phase coil subassembly is arranged to have a first phase current, the second phase coil subassembly is arranged to have a second phase current, and the third phase coil subassembly is arranged to have a third phase current such that together, the three overlapped coil subassemblies generate a balanced three-phase current that generates a rotating magnetic field to rotate the rotor to generate torque with the rotor.

16. An axial flux induction machine, comprising:
a housing;
a shaft rotatably coupled with the housing;
a first axial flux stator coupled with and disposed within the housing;
a second axial flux stator coupled with and disposed within the housing; and
an axial flux rotor disposed within the housing and residing between the first and second axial flux stators, the axial flux rotor coupled with the shaft and rotatable with respect to the first and second axial flux stators,
wherein each of the first and second axial flux stators comprises:
a stator core comprising a plurality of stator teeth and a plurality of slots defined between each pair of consecutive stator teeth of the plurality of stator teeth, and
a coil winding assembly disposed within the plurality of slots and around the plurality of stator teeth,
wherein the coil winding assembly comprises three overlapped coil subassemblies comprising a first phase coil subassembly, a second phase coil subassembly, and a third phase coil subassembly, each of the three overlapped coil subassemblies comprising one or more coils extending continuously around the stator core and arranged in a respective serpentine path through a respective group of slots of the plurality of slots.

17. The axial flux induction machine of claim 16, wherein the first phase coil subassembly comprises a first coil set, the second phase coil subassembly comprises a second coil set, and the third phase coil subassembly comprises a third coil set, the first coil set comprising a first pair of conductor strands arranged in a first serpentine path through a first group of slots of the plurality of slots and a second pair of conductor strands interlocked with the first pair of conductor strands and arranged in a second serpentine path through the first group of slots, the second serpentine path offset with respect to the first serpentine path.

18. The axial flux induction machine of claim 17, wherein the first pair of conductor strands comprises two round conductor strands extending parallel with respect to each other along the first serpentine path, and the second pair of conductor strands comprises two round conductor strands extending parallel with respect to each other along the second serpentine path.

19. The axial flux induction machine of claim 17, wherein the first phase coil subassembly comprises a first stack of coil sets comprising the first coil set and a first plurality of coil sets electrically connected to the first coil set, the second phase coil subassembly comprises a second stack of coil sets comprising the second coil set and a second plurality of coil sets electrically connected to the second coil set, and the third phase coil subassembly comprises a third stack of coil sets comprising the third coil set and a third plurality of coil sets electrically connected to the third coil set.

20. The axial flux induction machine of claim 16, wherein the coil winding assembly comprises a fill factor of between 55% and 75%.

21. The axial flux induction machine of claim 16, comprising:
a control system electrically coupled with and configured to transmit a power signal to the first and second axial flux stators, the power signal comprising three phases.

22. A method of installing a solid coil winding in an axial flux motor stator, the method comprising:
forming a first coil set of a coil winding assembly such that the first coil set fits within a first serpentine path that extends through a first group of slots of a plurality of slots of a stator core of an axial flux induction motor, the stator core comprising a plurality of stator teeth and the plurality of slots are defined between each pair of consecutive stator teeth of the plurality of stator teeth;
disposing the first coil set within a section of the plurality of slots of the stator core and around a section of the plurality of stator teeth such that the first coil set resides within the first serpentine path;
forming a second coil set of a coil winding assembly such that the second coil set fits within a second serpentine path that extends through a second group of slots of the plurality of slots; and
disposing the second coil set within the section of the plurality of slots of the stator core and around the section of the plurality of stator teeth such that the second coil set resides within the second serpentine path, the second serpentine path offset with respect to the first serpentine path.

23. The method of claim 22, wherein disposing the first coil set and second coil set comprises disposing a first phase coil subassembly within the section of the plurality of slots, further comprising:
disposing a second phase coil subassembly within a second set of the plurality of slots; and
disposing a third phase coil subassembly within a third set of the plurality of slots such that the first, second, and third phase coil subassemblies are interlocked with one another.
